(19) United States
(12) Patent Application Publication
(10) Pub. No.: US 2026/0268158 A1
(43) Pub. Date: Sep. 10, 2026

(54) DISTILLATION-BASED SYSTEM FOR A UNIVERSAL ENCODER FROM MULTIPLE TEACHERS

(71) Applicant: Naver Corporation, Gyeonggi-do (KR)

(72) Inventors: Mert Bulent SARIYILDIZ, Grenoble (FR); Philippe WEINZAEPFEL, Montbonnot-Saint-Martin (FR); Thomas LUCAS, Grenoble (FR); Pau DE JORGE ARANDA, Oxford (GB); Diane LARLUS, La Tronche (FR); Ioannis KALANTIDIS, Barcelona (ES)

(73) Assignee: Naver Corporation, Gyeonggi-do (KR)

(21) Appl. No.: 19/245,125

(22) Filed: Jun. 20, 2025

Related U.S. Application Data
(60) Provisional application No. 63/768,786, filed on Mar. 7, 2025.

(51) Int. Cl. G06N 3/096; G06N 3/0455

(52) U.S. Cl. CPC G06N 3/096; G06N 3/0455

(57) ABSTRACT

The present disclosure relates to a method and system for multi-teacher distillation or co-distillation to generate a universal encoder effective across diverse tasks. A heterogeneous set of teacher models, trained on distinct datasets, may be selected. Distillation data can be derived from the teachers' training sets. For each input (e.g., image), outputs may be generated using a student encoder and teachers' encoders. Teacher-specific projectors transform a student output for alignment with each teacher output. A distillation loss may be computed based on the difference between selected teachers' outputs and corresponding transformed student outputs. The student encoder may be updated using the distillation loss. This training process yields a distilled, task-agnostic universal encoder. When paired with teacher-specific decoders, the resulting model performs comparably to or better than the teacher models.

### CROSS-REFERENCE TO RELATED APPLICATIONS

This application claims the priority to and the benefit of U.S. Provisional Application No. 63/768,786, filed on Mar. 7, 2025, entitled “Distillation-based System for a Universal Encoder from Multiple Teachers”, which is hereby incorporated by reference in its entirety for all purposes.

### BACKGROUND

Autonomous systems, such as mobile robots and self-driving cars, are making significant contributions by providing smart and autonomous services in various fields, including manufacturing, healthcare, and logistics. These intelligent robots can enhance the efficiency and effectiveness of systems by performing tasks autonomously, such as material handling, environmental surveillance, transportation (e.g., self-driving cars), and conducting complex surgeries with higher accuracy and precision. In other roles, they may assist individuals with tasks such as cleaning, washing, cooking, and ensuring the security of homes or office buildings. Additionally, they can deliver packages and lunch boxes within office buildings. These robots or autonomous systems often utilize visual perception systems to carry out tasks such as semantic segmentation, depth estimation, human pose estimation, and 3D (three dimension) reconstruction. For each of these tasks, the perception system typically relies on a different, task-specific model (e.g., artificial intelligence models), resulting in high computational, memory, and storage demands. This increases the limitations on the capabilities of autonomous systems, particularly for real-time operations that require solving for many perception tasks simultaneously.

One potential solution to reduce the computational and memory requirements of autonomous systems is the development of a single model capable of handling multiple tasks through multi-task learning (MTL). MTL is a machine learning approach in which a model is trained on multiple tasks simultaneously, with the aim of leveraging shared information to improve performance. The underlying idea is that learning multiple related tasks together can lead to better generalization. However, MTL often fails to develop a universal or single model, as the tasks may have conflicting objectives, varying data distributions, and different levels of difficulty, making it challenging to balance the learning process across tasks. Moreover, the single model learned through MTL may struggle to transfer knowledge effectively between dissimilar tasks. As a result, the model may overfit certain tasks while underperforming on others, hindering optimal performance across all tasks.

Therefore, there is a demand for techniques, methods, or systems that can train a universal model capable of addressing multiple tasks accurately and efficiently, while also reducing the computational and storage costs of autonomous systems for real-time operation. Such techniques could lead to the development of lightweight systems with reduced costs, enhanced capabilities, and improved accuracy, facilitating deployment on edge devices such as robots and self-driving cars for real-time operations.

### SUMMARY

Some embodiments of the present disclosure relate to use of a plurality of teachers (pretrained models) to generate a universal encoder via multi-teacher distillation. A computer-implemented method includes identifying a set of teachers comprising a plurality of trained models. Each teacher of the set of teachers may include a teacher encoder. Also, each trained model of the plurality of trained models comprises a neural network model.

In some instances, each teacher of the set of teachers is trained on a respective training dataset. Each teacher of the set of teachers is designed for one or more tasks that may be different than other teachers of the set of teachers. In some instances, one or more of the plurality of teachers can be heterogeneous teachers. The set of teachers may include heterogenous teachers comprises task-agnostic teachers and specialized teachers.

A dataset can be identified for each teacher of the set of teachers for multi-teacher distillation. Distillation data may include the dataset corresponding to each teacher of the set of teachers. In some instances, the set of teachers may include at least one task-agnostic teacher that is trained on generic image datasets.

According to the disclosed techniques, a student encoder may be accessed. In some instances, the student encoder can be based on a vision transformer and the set of teachers (or the plurality of teachers) may be comprised of two or more vision models.

A multi-teacher distillation process can be performed by utilizing each image of the dataset corresponding to each teacher of the set of teachers or the distillation data. For an input image from the dataset or the distillation data, a student output can be generated by processing the (input) image with the student encoder. The student output may be comprised of a set of feature vectors.

In some embodiments, a task output of the input image can be one or more of semantic segmentation, monocular depth estimation, 3D pose understanding, and 3D scene reconstruction. The 3D scene reconstruction may include recovering camera parameters of a scene. Moreover, performing 3D pose understanding may include recovering a mesh of a human.

The student output can be transformed by leveraging a teacher-specific projector corresponding to each teacher of the set of teachers. In some instances, the teacher-specific projector corresponding to each teacher of the set of teachers includes a transformer projector. The transformer projector may share information across feature vectors of the set of feature vectors corresponding to multiple patches of the input image.

In some other instances, the teacher-specific projector corresponding to each teacher of the set of teachers comprises a ladder of projectors. The ladder of projectors may include a plurality of multi-layer perceptrons that are attached to intermediate layers and a final layer (or a last layer) of the student encoder. For one or more of the teachers, the teacher-specific projectors appended at different intermediate layers of the student are also further accompanied by loss function for distilling the features of the intermediate layers.

A teacher output can be generated for each teacher of the set of teachers by processing the image with the teacher encoder. In some instances, the teacher output corresponding to each teacher of the set of teachers may be normalized, for example, by using exponential moving average.

Afterwards, for each teacher of the set of teachers, a value of loss function can be determined based on the teacher output and an output of the corresponding teacher-specific projector. In some instances, the loss function may include cosine similarity and smooth-L1 loss.

Further, a distillation loss can be determined based on the value of loss function for a selected set of teachers of the set of teachers. In some instances, the selected set of teachers may include each teacher in the set of teachers. In some instances, the distillation loss for the input image of the dataset may be computed by summing up the value of loss function for each teacher of the set of teachers. In some other instances, regularization using teacher dropping can be performed to balance the distillation loss. During teaching dropping, the selected set of teachers may include a subset of teachers from the set of teachers.

Furthermore, parameters of the student encoder and parameters of the teacher-specific projector corresponding to each teacher of the set of teachers can be updated based on the distillation loss. The distillation process can be repeated for each image of the distillation data.

Finally, a trained student encoder can be output. In some embodiments of the present disclosure, each teacher-specific projector can be discarded after training the student encoder. Moreover, a decoder of one of the plurality of trained models may be fine-tuned while keeping the trained student encoder frozen. In some other embodiments, the teacher-specific projectors can be kept.

According to some aspects of the present disclosure, the trained student encoder may be accessed to perform a set of downstream tasks by using the trained student encoder and a decoder corresponding to the plurality of trained models, respectively. The set of downstream tasks performed can be greater than one task. The set of downstream tasks may be performed by sharing the trained student encoder with each decoder corresponding to the plurality of trained models. The set of downstream tasks may comprise one or more object detection tasks that may perform one or more of: semantic segmentation, monocular depth estimation, 3D pose understanding, and 3D scene reconstruction.

According to some embodiments, one or more input images may be captured with a camera mounted on an autonomous system. The autonomous system may be controlled based on a set of object detection tasks performed on the one or more input images. The set of object detection tasks may comprise one or more of: semantic segmentation, monocular depth estimation, 3D pose understanding, and 3D scene reconstruction.

In some embodiments, a system is provided that includes one or more data processors and a non-transitory computer-readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The present disclosure is described in conjunction with the appended figures.

FIG. 1 is a block diagram illustrating an overview of multi-teacher distillation architecture to train and to utilize (i.e., at inference) a student encoder (or a universal encoder) in accordance with some embodiments of the present disclosure.

FIG. 2 shows an illustrative example of training the student encoder using the multi-teacher distillation architecture in accordance with some embodiments of the present disclosure.

FIG. 3 shows another illustrative example of training the student encoder using the multi-teacher distillation architecture and by leveraging a ladder of projectors (LP) in accordance with some embodiments of the present disclosure.

FIG. 4A shows distilling the universal encoder (or DUNE) from heterogenous 2D and 3D teachers by leveraging the multi-teacher distillation architecture of FIG. 2 in accordance with an example implementation of the present disclosure.

FIG. 4B illustrates fine-tuning of task heads (or teacher decoders) with the universal encoder (or DUNE) of FIG. 4A in accordance with an example implementation of the present disclosure.

FIG. 5 illustrates a comparison of principal component analysis (PCA) visualization of encoder outputs of the teacher encoders and the student encoder in accordance with an example implementation of the present disclosure.

FIG. 6A shows visualization of random samples or images from 10 datasets out of 19 datasets that are used as distillation data in accordance with an example implementation of the present disclosure.

FIG. 6B shows visualization of random samples or images from the remaining 9 datasets out of 19 datasets that are used as distillation data in accordance with an example implementation of the present disclosure.

FIGS. 7A-7C show illustrative comparison of visualizations of attention maps that are extracted from the last layer of the distilled encoder and from the transformer projector of each teacher for a given input image.

FIG. 8 illustrates cumulative explained variance that is computed over features from three representative datasets, for three teacher encoders (solid lines) and student's projectors (dashed lines) in accordance with an example implementation of the present disclosure.

FIG. 9 illustrates correlation of loss updates during training for each pair of teacher models, comparing different projector designs and data-sharing strategies, in accordance with an example implementation of the present disclosure.

FIGS. 10A-10C illustrate side-by-side qualitative comparisons of 3D reconstruction results for MASt3R teacher and the DUNE student model, in accordance with an example implementation of the present disclosure.

FIGS. 11A-11B illustrate qualitative comparisons of human mesh recovery results between a Multi-HMR teacher model and the DUNE student model, based on images sampled from the BEDLAM validation set, in accordance with an example implementation of the present disclosure.

FIG. 12A illustrates a spider plot comparing different encoder models on the Feat2GS benchmark in accordance with an example implementation of the present disclosure.

FIG. 12B illustrates per-dataset quantitative evaluation results for various encoder models—DINO-v2, RADIOv2, MASt3R, and DUNE—on the Feat2GS benchmark, in accordance with an example implementation of the present disclosure.

FIG. 13A illustrates teacher dropping regularization through visualizations of loss curves for each of the two teachers during multi-teacher distillation in accordance with an example implementation of the present disclosure.

FIG. 13B illustrates teacher dropping regularization through visualizations of top-1 accuracy on ImageNet-1k when distilling from DINO and DeiT-III together versus distilling only from DeiT-III.

FIG. 14 shows plots of teacher coefficients αₜ during distillation for various values of ρ from DeiT and DINO in accordance with some example implementations of the present disclosure.

FIG. 15 illustrates the performance comparison of different UNIC encoders on different pairs of tasks.

FIG. 16A illustrates top-1 accuracy drop after [symbol] 1-norm-based unstructured weight pruning for UNIC and teacher models, in accordance with an example implementation of the present disclosure.

FIG. 16B shows top-1 accuracy variation under PCA-based feature dimensionality reduction for UNIC and teacher models, in accordance with an example implementation of the present disclosure.

FIG. 17 shows an example flowchart of multi-teacher distillation to train the universal encoder in accordance with some embodiments of the present disclosure.

FIG. 18 is a block diagram of an example computing system that may be utilized to perform one or more aspects of the disclosure described herein.

FIG. 19 illustrates an example system architecture in which the methods or techniques according to the present disclosure may be performed.

FIG. 20 is a functional block diagram of an example control system of an autonomous machine in accordance with some embodiments of the present disclosure.

### DETAILED DESCRIPTION

The present disclosure discloses embodiments relating to a multi-teacher distillation architecture for combining several (trained) models into a single, universal model. More specifically, techniques are provided to train a universal encoder (or a student encoder) through knowledge distilling from several teachers (or trained models) simultaneously. According to some embodiments, a technical solution is provided in the present disclosure to a technical problem of training or learning a universal model that can address several tasks with good accuracy while maintaining low computational cost and storage requirements for real-world deployment.

One existing approach to combine trained models into a single model involves extracting features using each trained model and either concatenating or fusing them for downstream tasks. However, this approach is often impractical due to limited storage, memory, and computing capacity of autonomous systems or edge devices. Another approach is to merge trained models together typically under the assumption that models may have the same architecture and size. Given the diverse nature of tasks and models, this approach is also not possible. Therefore, the present disclosure focuses on knowledge distillation from several models to train a universal model.

In some embodiments of the present disclosure, the multi-teacher distillation architecture leverages heterogeneous teacher distillation or co-distillation that includes teacher models with substantial differences both in the design goals and the data they are trained on. The term ‘co-distillation’ may refer to a technique where multiple teacher models, often with different architecture or training methods, collaboratively guide the training of a single student model to enhance its performance and generalization across a diverse set of tasks. According to the disclosed technique, a universal encoder can be trained using the multi-teacher distillation architecture, which can replace the teacher encoders and can be combined with decoders suited to each downstream task.

In some instances, for heterogeneous teacher distillation or co-distillation, a set of teachers may be selected that satisfy the following two properties. Firstly, teachers in the set of teachers cover a heterogeneous set of tasks. For instance, both task-agnostic teachers and specialized teachers (task-specific) may be jointly distilled. Task-agnostic teachers, aimed at producing representations that generalize across tasks, and specialized teachers that achieve state-of-the-art performance on one specific task. Task-agnostic teachers may refer to models trained on proxy tasks such as self-supervised objectives like context prediction or photometric invariance. Task-agnostic teachers aim to capture visual priors that are useful on a large range of tasks. These models (task-agnostic) are recognized for the generalization strength of their representations. Examples include but are not limited to visual encoders (i.e., foundation models) such as DINO-v2, CLIP, or SAM.

Moreover, the specialized teachers may represent models that are designed for specific (perception) task domains, such as 3D pose understanding (generally 3D pose understanding includes pose understanding for humans and animals other than humans (e.g., dogs, cats, etc.) as well as humanoid robots (or more generally animal robots)). The specialized models are typically trained with either weak or strong supervision and may leverage domain specific parametrizations during training. Models such as Depth Anything, MASt3R (see U.S. application Ser. No. 18/976,981, which is incorporated herein by reference), and multi-HMR (see U.S. patent application Ser. No. 18/987,215, which is incorporated herein by reference) contain vision transformer (ViT) encoders, and target domains such as 3D scene reconstruction or human pose understanding, may need varying levels and types of annotations.

Secondly, teachers in the set of teachers may be trained on heterogeneous data. During co-distillation, teachers that are trained on large generic image datasets (such as a dataset crawled from the web), may be jointly distilled together with teachers trained on highly curated and potentially carefully annotated datasets of natural or synthetic images. Thus, the selected teachers may vary with respect to both the tasks they are tackling and the datasets on which they were trained. Further, by inspecting patch features (e.g., a feature vector that is generated after processing an image patch using a teacher) produced by each of the teacher of the set of teachers on a given patch, the heterogeneity of teachers may be clearly visible.

In some aspects of the present disclosure, given the heterogeneity in training data across teachers, the choice of data for joint distillation of teachers becomes less straightforward. For example, foundation models such as DINO-v2 may be trained on generic data e.g., natural images, whereas the encoders of specialized models may be trained on diverse types of data (e.g., synthetic data from 3D engines, CAD models, simulators, or images rendered from structure-from-motion reconstructions). The training data of teachers vary even in terms of content, from small groups of people for human mesh recovery to empty indoor rooms and outdoor buildings for 3D.

Therefore, in co-distillation, an optimal distribution of data (or the choice of distillation data) to distill from is not trivial. Data associated with a specific teacher can be irrelevant or even harmful to others. Hence, techniques disclosed in the present disclosure to control or choose which data gets forwarded to each projector, i.e., teacher-specific modules that are jointly learned with the student encoder during distillation. According to the disclosed multi-teacher distillation architecture, the teacher-specific modules (also referred herein as ‘projectors’) may be utilized to address the issue of teacher-specific or ‘complementary’ information stemming from the different training objectives.

In some instances, during distillation process (or training of the universal encoder), each teacher-specific projector may only receive data associated with the corresponding teacher (also referred herein as ‘No data sharing’). In some cases, each teacher-specific projector may receive all the data associated with all the teachers in the set of teachers (also referred herein as ‘Full data sharing’). In some other cases, each teacher-specific projector may receive data associated with the corresponding teacher and the generic data (also referred herein as ‘Generic data sharing’).

While distilling a universal encoder, the objective is to learn the parameters of a student encoder (or the universal encoder) that can produce outputs closely aligned with those of all teachers simultaneously. In some instances, the student model may be comprised of visual encoder based on the ViT architecture. An input image may be processed with the student encoder to generate a set of feature vectors that includes a feature vector corresponding to each patch of the input image and an optional global feature vector corresponding to a CLS token. Afterwards, the input image may be processed by each teacher of a given set of N teachers to generate teacher outputs (or features sets). Each teacher may get images of same resolution and size etc. Each input image may be split into non-overlapping patches (or tokens). The output of encoders (e.g., the teachers output or the student output), i.e., the feature vector is per patch of the input image. In some instances, the teachers' output (or feature vectors) may be normalized or standardized, e.g., using an exponential moving average. Furthermore, the feature vectors and weights of the student encoder (or a distilled encoder) may achieve lower redundancy as compared to the teachers.

The teacher-specific projectors can be used to transform the set of features (global and patch token features) generated by the student encoder. Afterwards, a distillation loss may be computed between the outputs of teacher-specific projectors and the corresponding teacher outputs. In some instances, the loss function may include a cosine-similarity and smooth L1-loss. The distillation loss may be computed based on the value of loss function of a selected set of teachers of the set of teachers. In some instances, the distillation loss may be computed by summing up a value of loss function for each teacher of the set of teachers. Further, the present disclosure also discloses an effective strategy (also referred herein as ‘teacher dropping’) for balancing the teacher's influence in the multi-teacher distillation, resulting in increased gains by the distilled encoder (or the universal encoder). In some other instances, regularization may be performed via teacher dropping based on the magnitude of the loss function value in order to balance the distillation loss.

In some instances, the teacher-specific projectors or simply projectors may include a two-layer multi-layer perceptron (MLP) appended to the top (or output) of the student encoder (also referred herein as ‘simple projectors—SP’). In some other instances, multiple additional MLPs can be attached to intermediate layers of the student encoder (also referred herein as ‘ladder of projectors—LP’). In yet some other instances, each projector may be composed of a single transformer block (also referred herein as ‘transformer projectors—TP’). After distillation, the projectors can be thrown or kept.

According to some aspects of the present disclosure, the projectors can be expendable modules, i.e., the projectors can be discarded after the co-distillation. The goal or objective of the multi-teacher distillation is to learn a single, universal encoder that can be interfaced with any existing decoder modules of the teachers. Thus, the universal (shared) encoder may manage a large number of diverse tasks simultaneously, for example, all tasks where the multiple teachers excel. By discarding the projectors and replacing the teachers' encoders with a single, universal encoder, no additional computational cost is added in the teacher models due to projectors, whereas the total computational cost to solve multiple tasks can be reduced multi-fold due to a single encoder. Moreover, the size and memory of the universal encoder becomes invariant to the number of teachers and more importantly, does not impact inference time. After co-distillation and discarding the projectors, any task-specific decoder heads that already exist in each teacher may need to be fine-tuned while keeping the universal encoder frozen. At inference, the feature vectors (generated by the universal encoder) can simply be passed to one or more decoder heads (of teachers) for specific tasks, e.g., computer vision tasks. In some cases, it could be favorable to also include the projectors, e.g., for the cases where the task heads are linear classifiers (e.g., semantic segmentation) and contain only a small number of task-specific parameters.

According to some embodiments of the present disclosure, the heterogeneous teacher distillation or co-distillation setting can be used to train a single, universal encoder to solve a number of specialized tasks, for example, semantic segmentation, human pose estimation, monocular depth estimation, binocular 3D tasks, and the like. Moreover, the universal encoder may retain strong generalization capability due to the generic nature of some of the teachers in the set of teachers (e.g., foundation models or vision encoders).

In some embodiments, the multi-teacher distillation architecture may include two or more, or three or more teacher models. At least one, or at least two of the teacher models may correspond to task-agnostic models. In some other instances, at least one, at least two, at least three, or each of the teacher models may correspond to task-agnostic models. In yet some other instances, at least one, at least two, at least three, or each of the teacher models may correspond to specialized models.

In some embodiments of the present disclosure, during co-distillation, regularization may be performed to avoid overfitting one or more tasks by the distilled encoder (or the student encoder 110) and to represent each teacher equally well. In some instances, the regularization or loss balancing is performed via teacher dropping. For instance, for each input image (or patch), losses can be computed for all teachers. The absolute magnitudes of the losses can be used to drop teachers, i.e., keeping the teacher, whose loss magnitude is maximum and dropping any other teacher with some probability. Thus, the distillation loss for the image (or patch) is a sum of a subset of those losses. This subset always includes the teacher(s) with highest loss for this image. Other teachers are included in the subset with a fixed probability. In some other instances, regularization may be performed using AdaLoss weighting scheme or with manual weighting.

It may be appreciated that the techniques disclosed in the present disclosure such as multi-teacher distillation architecture can be used to develop lightweight systems or autonomous systems (having a single, universal encoder) that can perform multiple tasks in real-time or near real-time, while effectively reducing the compute multi-fold at inference time. Moreover, it may be further appreciated that the disclosed multi-teacher teacher architecture provides a generic method for combining teachers, which is not limited to certain types of teachers, or losses, does not need labeled data, nor classifiers associated with each teacher for obtaining pseudo-labels. Furthermore, according to example implementation of the disclosed techniques, for example, distilling a universal encoder for 2D and 3D tasks from heterogenous teachers achieves performance comparable to the (large) teachers, and in some cases even outperforming the teachers on their respective tasks.

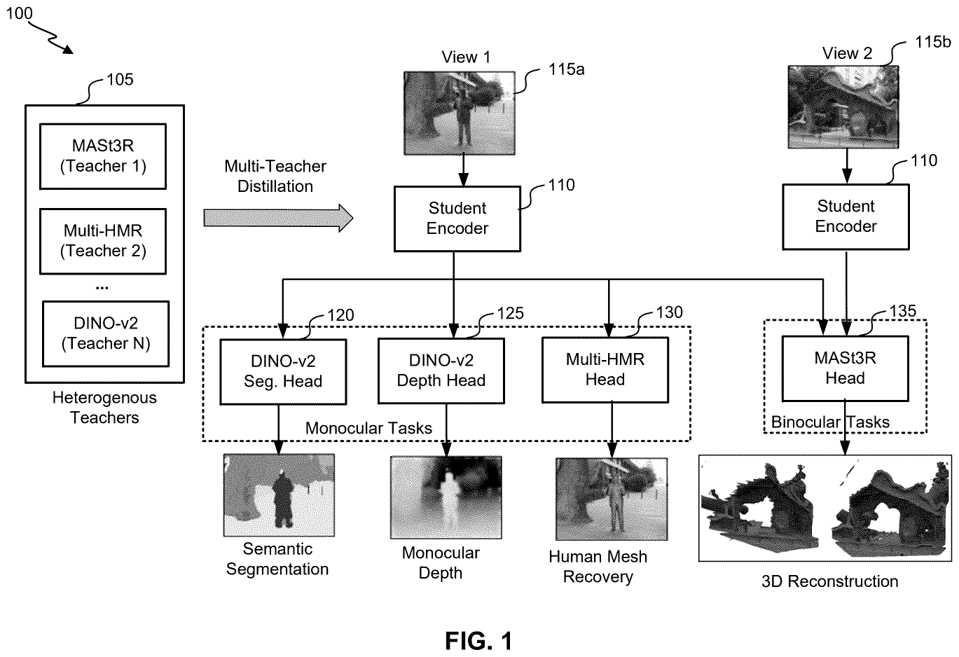

FIG. 1 is a block diagram illustrating an overview of multi-teacher distillation architecture to train and to utilize (i.e., at inference) a student encoder 110 (or a universal encoder) in accordance with some embodiments of the present disclosure. Knowledge distillation (KD) was initially introduced as a model compression technique, where the goal is to train a smaller student model from the output of a teacher model. The present disclosure discloses techniques for distilling knowledge, not in the sense of distilling a big model to a smaller model, instead in the sense of distilling several teacher models into a single student model (e.g., to distill multiple task-specific encoders to train a single multi-task encoder i.e., the student encoder 110).

According to some aspects of the present disclosure, multi-teacher distillation can be used to combine multiple models into one. More specifically, multi-teacher distillation can be used to unify the encoders of multiple teacher models into a single (student) encoder and replaces the encoder of each teacher with the single (student) encoder. The student encoder 110 can be obtained by distilling the outputs of the teacher encoders on well-chosen data (or distillation data). For instance, the teacher models can be foundation models and/or vision models. The foundation models are large-scale, general-purpose models that are trained on massive datasets and are designed to be adaptable to many downstream tasks. The foundation models can serve as the base for fine-tuning or adaptation to specific tasks (e.g., summarization, classification, captioning, etc.). Vision (foundation) models are designed specifically for visual tasks such as image classification, object detection, segmentation, and the like. Examples of popular vision models include DINO-v2, CLIP, and SAM (segment anything model). The vision models are trained on massive web-crawled image datasets and provide representations useful for multiple downstream tasks. In some instances, to unify the encoders of several of these foundation (e.g., vision) models into a single compact encoder via multi-teacher distillation, the distillation can be performed on a dataset of a similar nature (to the training dataset of teachers), composed of ‘generic’ web-crawled images.

According to some embodiments of the present disclosure, heterogeneous teacher distillation or co-distillation may be performed using a set of teachers comprising two or more heterogeneous teachers 105. Heterogeneous teacher distillation or co-distillation can be considered as a challenging multi-teacher distillation setup where teacher models may vary with respect to (a) the design goals, and (b) the data they were trained on. The set of teachers may satisfy the following two properties. Firstly, the teachers cover a heterogeneous set of tasks, e.g., the teachers vary in the design objectives for which they were trained. This includes task-agnostic teachers (models with strong generalization properties, typically self-supervised and trained on pretext tasks) together with specialized models tailored to specific tasks. Secondly, individual training sets corresponding to each teacher of the set of teachers may comprise heterogeneous data. Thus, heterogeneous teacher distillation or co-distillation may jointly distill teachers trained on huge generic image datasets crawled from the web, together with teachers trained on highly curated and potentially carefully annotated datasets composed of natural or synthetic images.

Task-agnostic teachers may refer to models trained on proxy tasks such as self-supervised objectives like context prediction or photometric invariance. The task-agnostic models may be comprised solely of a (visual) encoder and be referred to as a foundation (vision) model, for example, DINO-v2. These models aim to capture broadly used visual priors that are useful for a wide range of tasks. Such models are typically evaluated on tasks for which the encoder representations can be used directly, such as k-NN or zero-shot classification, or by training linear classifiers for various classification tasks at the image or pixel level (e.g., semantic segmentation or monocular depth estimation using a linear head). Notably, the task-agnostic models are recognized for the generalization strength of their representations, which are beneficial to a wide range of downstream tasks. However, task-agnostic models usually underperform as compared to the specialized models trained with supervised or privileged information.

Specialized teachers may focus on specific perception domains, such as 3D for MASt3R or human pose understanding for multi-HMR. The specialized teachers or specialized models are typically trained with weak or strong supervision. Moreover, although specialized teachers frequently use ViT encoders, the models incorporate domain-specific parameterization and may require varying levels and types of annotation. The encoders of specialized teachers may differ in both the type of information being encoded (e.g., a skinned multi-person linear model (SMPL) parameters versus dense matches) and the manner of encoding it (e.g., multi-HMR captures the full 3D human pose in a single patch token).

Further, the distinction above between the task-agnostic teachers and the specialized teachers highlights the trade-off between generalization to novel tasks, afforded by task-agnostic teachers, and performance on specialized tasks coming from specialized teachers. By incorporating this distinction into our formulation, the disclosed heterogenous teacher distillation setup can be interpreted in two ways. First, a technique to enhance the performance of specialized teachers on certain novel tasks by leveraging task-agnostic models. Second, as a way to improve the performance of self-supervised foundation models on the set of specialized tasks.

In some embodiments of the present disclosure, the multi-teacher distillation is performed using teachers that are heterogeneous in nature, i.e., trained across distinct domains and solving diverse tasks. Each teacher model may be comprised of a teacher encoder and a task-specific head (i.e., decoder). The teacher encoders may vary in size and architecture. The multi-teacher distillation may provide flexibility in terms of no a-priori constraints on the architecture and size of the student encoder 110. In some instances, the heterogeneous teachers 105 may include both task-agnostic teachers, for example, models with strong generalization properties (typically self-supervised and trained on pretext tasks) and specialized teachers that are tailored to specific tasks. For instance, the heterogenous teachers 105 may include models such as MASt3R for binocular 3D tasks, multi-HMR for human mesh recovery, and DINO-v2 for 2D tasks like monocular depth estimation and semantic segmentation. DINO-v2 is a popular visual foundation model that generalizes to various visual downstream tasks including semantic segmentation or monocular depth estimation. It may be appreciated that the binocular 3D tasks and human mesh recovery are much different tasks than typical visual tasks such as classification, segmentation, and the like.

A heterogenous dataset (or distillation dataset) may be identified for co-distillation. Co-distilling these heterogenous teachers 105 by leveraging the disclosed multi-teacher distillation architecture may train the student encoder 110 (or the universal encoder) that can replace the teacher encoders and be combined with decoders (or task-specific heads) suited to each downstream task. For example, during inference, an image (view 1) 115a can be encoded with the student encoder 110 and the output (feature vectors) of the student encoder 110 can be fed to task-specific heads or decoders of teachers. Examples include but are not limited to DINO-v2 segmentation head 120 to generate semantic segmentations, DINO-v2 depth head 125 to estimate monocular depth, multi-HMR head 130 to obtain human mesh recovery based on the image (view 1) 115a. Moreover, for binocular tasks, a second image (view 2) 115b can also be processed using the student encoder 110. A MASt3R head 135 can be used to process the encodings (or feature vectors) of both images 115a-b and to generate 3D representation.

According to some embodiments, heterogeneous teacher distillation tackles specialized tasks such as segmentation, human pose estimation, and 3D reconstruction with a single encoder, while preserving the generic nature of some teachers and ensuring strong generalization. Unlike multi-task learning (MTL) or training, distillation relies on teacher outputs instead of ground-truth labels and does not need access to the original training data of the teachers.

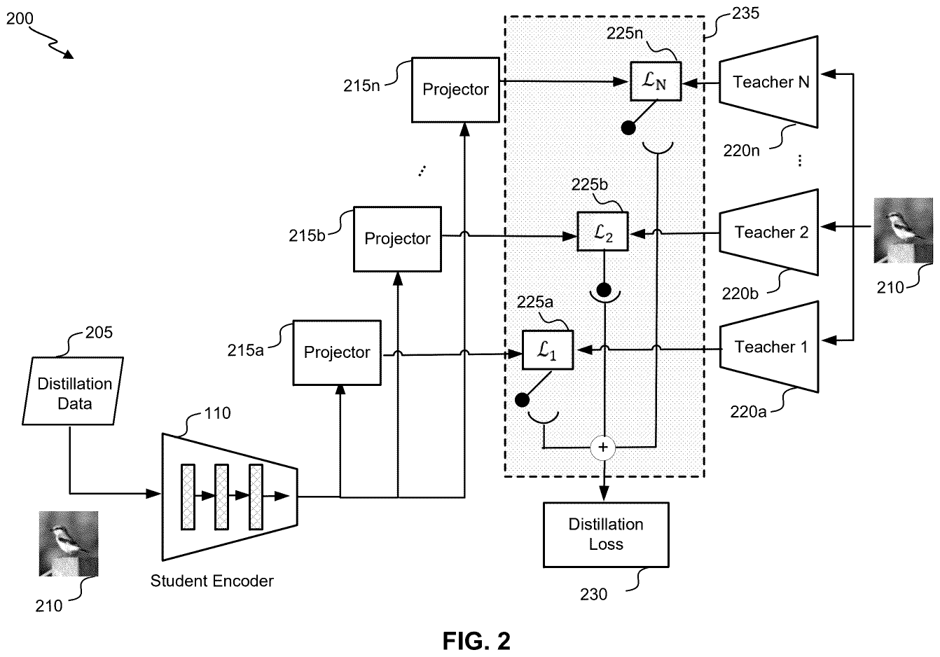

FIG. 2 shows an illustrative example 200 of training the student encoder 110 using the multi-teacher distillation architecture in accordance with some embodiments of the present disclosure. An input image 210 from distillation data 205 may be fed to each teacher (or teacher encoders 220a-n) and to the student encoder 110. Each teacher may get the input image 210 of same resolution and size etc. The input image 210 can be split into non-overlapping patches (or tokens). The student encoder 110 and the teacher encoders 220a-n may generate output for each patch of the input image 210. The output (e.g., feature vectors from the last layer) of the student encoder 110 can be transformed using projectors 215a-n or teacher specific modules. Moreover, feature standardization may be applied to each teacher's output by normalizing the outputs (or feature vectors) of the teacher encoders 220a-n to zero mean and unit variance. A loss function value ( [symbol] ₁, . . . , [symbol] _{N}) may be computed at 235 for each teacher based on the normalized teacher output and an output of a corresponding projector or teacher-specific module. Further, in some instances, a distillation loss 230 can be computed by summing all the loss function values 225a-n for the input image 210. In other instances, a loss balancing approach may be used such as teacher dropping to compute the distillation loss 230. The parameters of the student encoder 110 and the projectors 215a-n can be updated based on the distillation loss 230. The training or distillation process can be repeated for each image of the distillation data 205.

In some instances, the student encoder 110 and the teacher encoders 220a-n may represent a visual encoder based on the ViT architecture. These models may take an image x∈I as input and produce a set Z∈ [symbol] of feature vectors, where [symbol] ∈ [symbol] ^{(HW+1)×d}. This feature set includes HW features for the H×W patches, along with an optional global feature corresponding to a CLS (i.e., classification) token. Each feature vector may have a dimensionality of d. For instance, the input image 210 (e.g., a 448×448 RGB image) may be split into fixed-size patches (e.g., 14×14) by each encoder model (student and the teacher). The input image 210 of size 448×448 with a 14×14 patch size would result in (448/14)²=1024 patches. Each patch can be flattened (turned into a vector) and projected into an embedding space, i.e., like turning a small square of the image into a feature vector by the encoders. A special token called the CLS token is prepended to the sequence of patch embeddings. The CLS token acts like a ‘summary’ token. After the transformer (ViT) processes all patches of the input image 210, the final embedding of the CLS token is used as a representation of the entire input image 210. The CLS token is useful for tasks like classification, retrieval, or image-level prediction.

Let [symbol] = [symbol] ₁, . . . , [symbol] _{N} represent the set of N teachers for distillation and each teacher parameterized by a teacher encoder tᵢ(x). The co-distillation objective is to learn the parameters of the student encoder 110 f(x) that produces outputs closely aligned with those of all teachers simultaneously. The student encoder 110 can be trained by applying the distillation loss 230 on both the global and patch token features. Let f(x): I→ [symbol] denote the student encoder 110, and hᵢ represents a teacher-specific projector for each teacher [symbol] ᵢ, i=1, . . . , N. A loss function may include the cosine-similarity and smooth-L1 losses. The distillation loss 230 is minimized during training of the student encoder 110, which is a combined loss of all teachers:

$${ℒ}_{distil} = {\sum }_{i = 1}^{N} λ \cdot {ℒ}_{c o s} ( {f}_{i} \cdot ( x ) , {t}_{i} ( x ) ) + ( 1 - λ ) \cdot {ℒ}_{sl 1} ( {f}_{i} ( x ) {t}_{i} \cdot ( x ) ) , \qquad Equation 1$$

where fᵢ=hᵢ(f(x)). In Equation 1, λ [symbol] _{cos} and [symbol] ₛₗ₁ denote a (loss weighting) coefficient, the cosine loss and smooth-l₁ loss, respectively.

During multi-teacher distillation, projectors 215a-n or teacher-specific modules may be utilized to address the issue of teacher-specific or “complementary” information stemming from the different training objectives of the teachers. The patch representations (the global and patch token features) from the encoder (e.g., the student encoder 110 or the teacher encoder) and the interactions across patch representations can differ significantly between teachers. For example, the multi-HMR model may need pose information for the whole human body to be captured in the representation of the patch where the head and nose are detected, since the corresponding decoder (of the multi-HMR model) only takes such patches as input.

In some instances, a simple projector (SP) design comprising of a two-layer MLP can be used as projectors 215a-n. The SP can be appended to the top (or last layer) of the student encoder 110 for each teacher. In some other instances, more complex designs can also be used such as attaching multiple additional MLPs to intermediate layers of the student encoder 110. This design is referred herein as ‘ladder of projectors’ (LP). The LP improves information flow to the teacher-specific parameters and may improve distillation across teachers and tasks. Both the SP and LP projectors may operate per-patch, i.e., teacher-specific parameters may not explicitly capture patch feature interactions. Therefore, according to some embodiments, inter-patch interactions that are specific to each teacher may need to be embedded in the attention layers of a shared encoder. In other words, the shared encoder has to model all patch interactions relevant for a particular teacher.

For projectors 215a-n to model interactions across patches, attention-based efficient projectors are disclosed in the present disclosure. Thus, each projector may be composed of a single transformer block:

$$a = f ( x ) + SA ( LN ( f ( x ) ) ) \qquad Equation 2$$

$$m = a + MLP ( LN ( a ) ) \qquad Equation 3$$

$${h}_{i} = Linear ( m ) \qquad Equation 4$$

In Equations 2-4, LN denotes layer normalization, SA represents a multi-head self-attention layer, MLP includes a two-layer perceptron, and Linear represents a fully-connected layer. This projector design is also referred herein as a transformer projector or TP.

The present disclosure discloses a simple scheme for loss balancing during multi-teacher distillation and is referred herein as ‘teacher dropping’. In the teacher dropping, the term ‘drop’ refers to zero-out the loss for a particular teacher. According to the disclosed teacher dropping technique, absolute magnitudes of the losses ( [symbol] ₁, . . . , [symbol] _{N}) can be used directly to select which teachers to drop, i.e., keeping the teacher, whose loss magnitude is maximal and dropping any other teacher with some probability. The teaching dropping method is non-parametric and simply exploits the fact that feature space losses on constrained representations are comparable. In some instances, the loss-based teacher dropping may be performed at image level. At each iteration and for every input image 210 of the distillation data 205, a binary coefficient αₜ={0,1} can be defined for each teacher t that is multiplied with the corresponding loss [symbol] ₜ. This determines whether teacher t would be dropped or not for that image with probability p. To make sure there is always some signal (or distillation loss 230) to learn from, the teacher with the maximum magnitude loss will not be dropped, i.e., the teacher that the student encoder 110 (current state) approximates least well. All other teachers can be dropped with probability p. Specifically, and for each input image 210, the coefficient for teacher t∈ [symbol] is given by:

$${α}_{t} = \{ \begin{matrix}1 , & if {ℒ}_{t} = {max}_{t} {ℒ}_{t} , \\ 1 - δ , & if {ℒ}_{t} \neq {max}_{i} {ℒ}_{i} , with δ ∼ Bernoulli ( p )\end{matrix} . \qquad Equation 5$$

For each input image 210 from the distillation data 205, the teacher that is least well approximated in the current iteration will always be used. In other instances, the teacher dropping technique can be used with patch-level teacher dropping.

According to some aspects of the present disclosure, the distillation data 205 may be selected based on the set of teachers. In some instances of multi-teacher distillation, when all the teachers in the set of teachers are task-agnostic or foundation models, then the distillation data 205 can be a ‘generic’ dataset, for example, LAION, DataComp1B, ImageNet-1K, and the like. Foundation models like DINO-v2, SAM, and CLIP are all trained on data of a similar nature, i.e., ‘generic’ datasets. In other instances, such as heterogenous teacher distillation or co-distillation, one of the main challenges is the diversity of teachers' training data that spans multiple visual domains. For instance, the distillation data 205 may need to be defined to jointly distill visual encoders trained on natural images, i.e., DINO-v2, alongside specialized encoders trained on diverse types of data (e.g., synthetic data from 3D engines, CAD models, simulators, etc.) and with diverse content (e.g., data focused on small groups of people in the case of Multi-HMR, or empty indoor rooms and outdoor buildings for MASt3R). When jointly distilling teachers trained on such heterogeneous data, the choice of the distillation data 205 becomes less straight forward, for instance, whether data from all teacher domains may be needed or the generic data may be sufficient for co-distillation.

In co-distillation, the distillation data 205 or optimal distribution of data to distill from is not obvious. Data associated with a specific teacher can be irrelevant or even harmful to others. Therefore, it makes sense to control which data gets forwarded to each teacher-specific projector. In the present disclosure, techniques (e.g., data sharing strategies) are disclosed to address the technical challenge of whether data from all teacher domains may be needed or the generic data may be sufficient for co-distillation or heterogenous teacher distillation.

Let [symbol] ᵢ denote the data (e.g., training data) associated with a teacher [symbol] ᵢ ∈ [symbol] with i=1, . . . , N. According to the disclosed techniques, [symbol] ᵢ∪ [symbol] ⱼ=∅ for all specialized teachers i, j, i.e., the specialized teachers are all trained on different datasets. Moreover, all task-agnostic teachers may be trained with the same generic data [symbol] _{g}. Let hᵢ denote the projector associated with teacher i. Three simple ways of sharing datasets across teachers are disclosed:
1. No data sharing: Projector hᵢ receives only [symbol] ᵢ, i.e., the data associated with its teacher [symbol] ᵢ.
2. Full data sharing: Projector hᵢ receives all data, i.e., ∪ [symbol] ᵢ, i=1, . . . , N, as well as generic data [symbol] _{g}.
3. Generic data sharing: Projector hᵢ receives only [symbol] ᵢ (the data associated with [symbol] ᵢ) and generic data [symbol] _{g}.

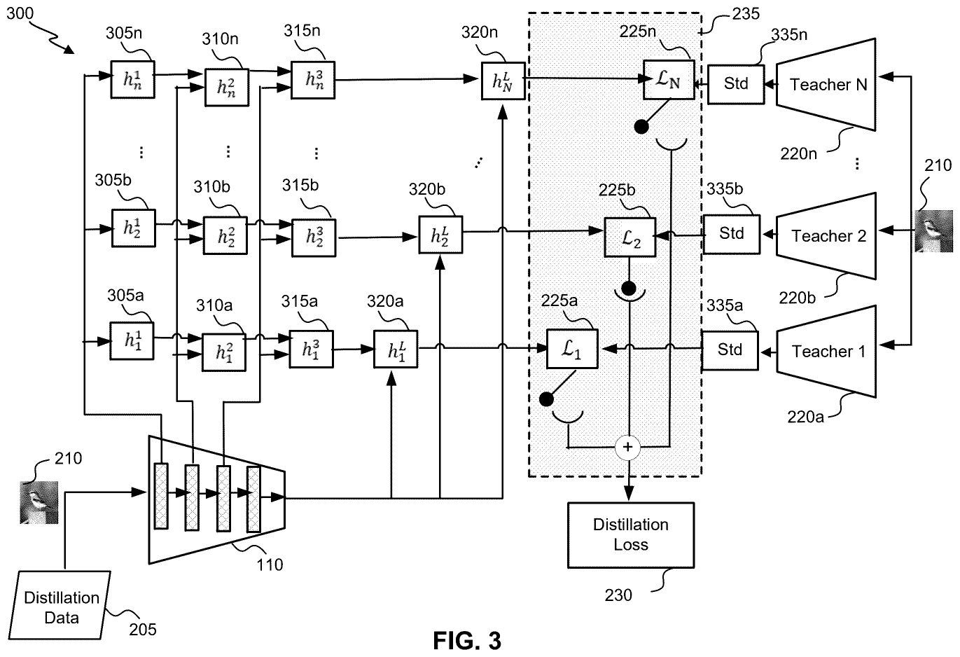

FIG. 3 shows another illustrative example 300 of training the student encoder 110 using the multi-teacher distillation architecture and by leveraging a ladder of projectors (LP) in accordance with some embodiments of the present disclosure. In some embodiments, each teacher t∈ [symbol] can be a ViT encoder that maps an image x to a set of d-dimensional feature vectors y_{t,i}=fₜ(x; i) for token i which can either be one of the H×W patch tokens from [symbol] or the global CLS token c. The aim of the multi-teacher distillation is to learn the parameters fₛ or f of the student encoder 110 by distilling N teacher models [symbol] = [symbol] ₁, . . . , [symbol] _{M}, such that the output representations zᵢ=fₛ(x; i) excel at all the tasks that any of the teachers also excels at.

Each of the teacher-specific projector heads 320a-n hₜ may transform the output (or each patch feature token) of the student encoder 110 into a teacher-specific representation hₜ(zᵢ). The loss for each teacher is then computed on hₜ(zᵢ), the output of the corresponding projector head. The projector heads can be considered expendable, i.e., they can be removed after distillation and may not be part of the student encoder 110. The goal of the projectors 215a-n is to assist the learning process. According to some embodiments, the teacher-specific projector heads 320a-n can be multi-layer perceptrons (MLPs) with two linear layers, GeLU non-linearity, and hidden dimension of dₕ=4d, where d is the feature dimension.

In some instances, a combination of two common distillation losses, i.e., cosine and smooth- [symbol] 1 may be utilized to compute loss function values 225a-n. The loss function for token i from teacher t can be represented as:

$${ℒ}_{t} ( x ; i ) = \frac{{ℒ}^{c o s} ( {h}_{t} ( {z}_{i} ) , {y}_{t , i} ) + {ℒ}^{s l 1} ( {h}_{t} ( {z}_{i} ) , {y}_{t , i} )}{2} \qquad Equation 6$$

The loss may be computed separately for the CLS token and each of the patch tokens [symbol] . In some instances, to get the final loss or the distillation loss 230, the individual losses from all the teachers can be summed over the CLS token c and the tokens of all patches for the input image 210.

$$ℒ ( x ) = {\sum }_{t ϵ 𝒯} ( \frac{{ℒ}_{t} ( x ; c ) + \frac{1}{\vert 𝒫 \vert} {\sum }_{p ϵ 𝒫} {ℒ}_{t} ( x ; p )}{2} ) \qquad Equation 7$$

In Equation 7, | [symbol] | is the number of patch tokens. In the illustrative example 300, the distillation loss 230 is computed using the teacher dropping technique as explained in the description of FIG. 2, i.e., individual losses from a subset of teachers will contribute towards [symbol] (x).

Further, to implement the ladder of projectors (LP) technique, multiple expendable (adapter-like) modules may be added in a complementary manner—as information highways that propagate data from intermediate layers of the student encoder 110 to the loss function more directly. One approach may leverage intermediate layers to enhance distillation by attaching additional losses to those layers. This strategy introduces increased optimization difficulty. Moreover, tuning hyperparameters in the presence of extra losses becomes a combinatorial task, adding more complexity. These challenges are further amplified when distillation involves multiple teachers.

Therefore, according to the disclosed techniques, the existing teacher-specific projector heads 320a-n may receive input from intermediate layers. For this, expendable modules can be appended that connect all intermediate layer tokens directly to the teacher-specific projector heads 320a-n before the loss function. More specifically, MLP projectors (305a-n, 310a-n, 315a-n) may be attached to intermediate layers and augment the input of the teacher-specific projector heads 320a-n

$$( {h}_{t}^{L} ) .$$

Previously, as discussed in FIG. 2, the projectors 215a-n (SP or TP) may be operated only on the last layer of the student encoder 110. If z^{l} denote the l-th layer output of the student encoder 110 for l=1, . . . , L. The head for the ladder of projectors becomes:

$${h}_{t}^{L P} ( \{ {z}^{l} : l ∈ L \} ) = {\sum }_{l = 1}^{L} {h}_{t}^{l} ( {z}^{l} ) \qquad Equation 8$$

where

$${h}_{t}^{l}$$

denoted the MLP projector head attached after layer l∈L. The architecture of

$${h}_{t}^{l}$$

can be identical to hₜ. The architecture of

$${h}_{t}^{l}$$

can be identical to hₜ. Since multiple such projector heads are added, the hidden dimension

$${d}_{h}^{l}$$

when l<L.
may be reduced and can be set as

$${d}_{h}^{l} = d$$

when l<L.

According to some aspects of the present disclosure, the statistical inconsistencies across features may affect the multi-teacher distillation. Therefore, feature standardization 335a-n may be performed on each teacher's output. Feature standardization 335a-n may normalize teacher features (teacher's output) to zero mean and unit variance before computing the loss. Feature standardization 335a-n may equalize any differences between CLS and patch tokens and may also equalize tokens across teachers. According to disclosed techniques, such normalization statistics can be learned on the fly during distillation using an exponential moving average for convenience and generality. Feature standardization 335a-n may improve the performance of multi-teacher distillation for both image- and patch-level tasks.

In some instances, separate projector heads for CLS and patch tokens may be added. Beside statistical differences, the CLS and patch tokens are also conceptually different: CLS is a global token expected to encode image-level semantics whereas the patch tokens encode local information. Thus, to better capture these specifics from CLS and patch tokens, dedicated teacher-specific projector heads for each type of tokens may be added in some instances. This comes at no added cost in practice or at inference, since the projectors 215a-n can be discarded after distillation. However, they need not be discarded depending on the downstream task. Specializing the teacher-specific projector heads 320a-n to either CLS or patch tokens may further improve distillation performance.

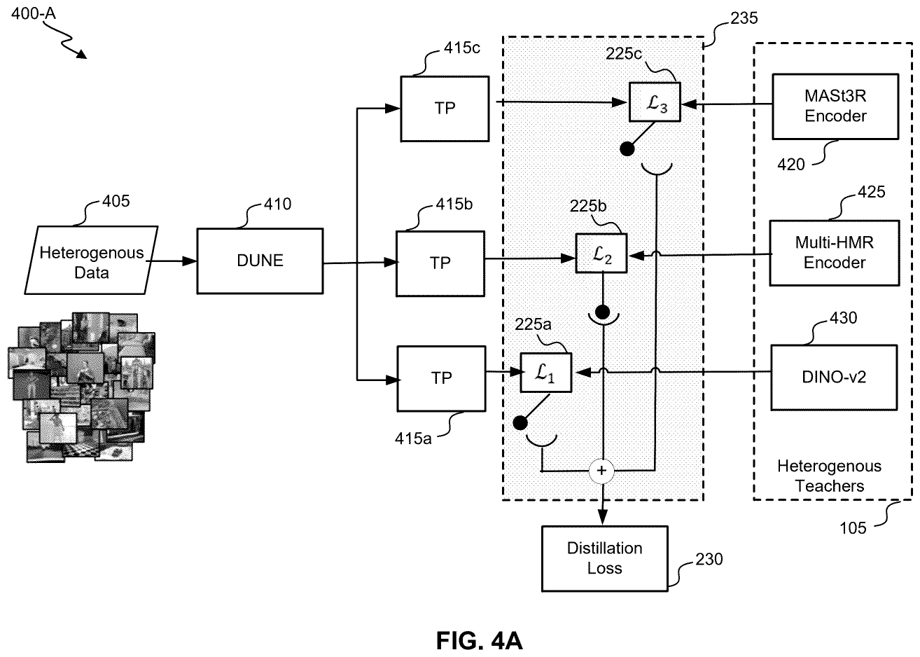

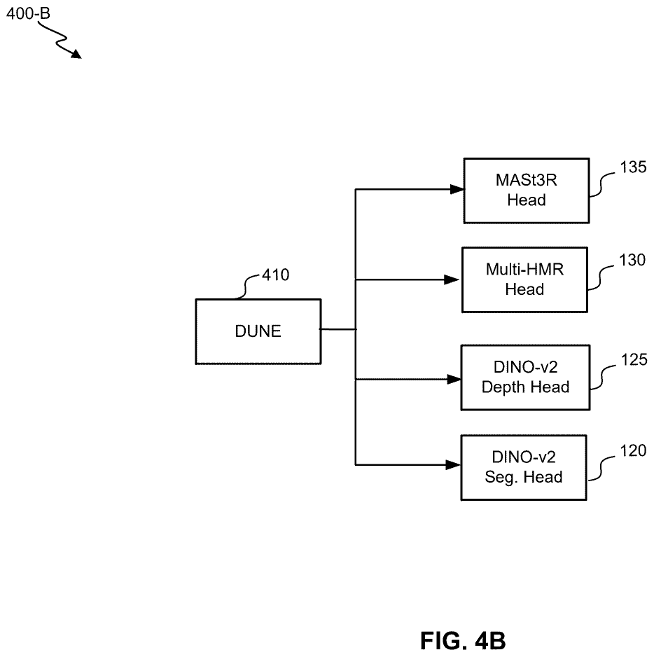

FIG. 4A shows distilling a universal encoder (or DUNE 410) from heterogenous 2D and 3D teachers by leveraging the multi-teacher distillation architecture of FIG. 2 in accordance with an example implementation of the present disclosure. The term ‘DUNE’ as used herein may refer to a universal encoder, obtained by co-distillation of heterogeneous 2D and 3D teachers. DUNE 410 can be trained via distillation from heterogeneous teachers across 2D vision, 3D vision, and 3D human perception. Heterogenous teachers 105 include MASt3R 420 (a 3D foundation model), multi-HMR 425 (human perception model), and DINO-v2 430 (2D foundation model).

Distillation can be performed using heterogenous data 405 that includes diverse data from multiple visual domains. Heterogenous data 405 may include but is not limited to synthetic data from 3D engines, CAD models, simulators, and with diverse content e.g., data focused on small groups of people, or empty indoor rooms, outdoor building. Moreover, loss balancing or regularization can be achieved using teacher dropping technique as explained earlier. In the example implementation, transformer projectors 415a-c may be utilized for improved performance. Multi-task inference can be achieved with a single encoder, i.e., DUNE 410 that excels in 2D vision, 3D understanding, and 3D human perception. DUNE 410 may retain strong generalization abilities and at the same time excel at multiple diverse tasks due to the disclosed heterogenous teacher distillation or co-distillation architecture.

FIG. 4b illustrates fine-tuning of task heads (or teacher decoders) with the universal encoder (or DUNE 410) of FIG. 4a in accordance with an example implementation of the present disclosure. According to some embodiments, the teacher-specific projectors 215a-n (or transformer projectors 415a-c) that are learned during training or distillation can be used during inference. This allows for a plug-and-play reuse of task-specific decoders, yet this results in more parameters, not only for the student encoder 110 itself but also for all the teacher-specific projectors 215a-n. The number of those additional parameters may scale linearly with the number of teachers.

Projectors 215a-n may become irrelevant if the decoder modules are jointly fine-tuned for the tasks to solve, once the student is trained. Such an approach can offer several advantages. It introduces no additional modules (projectors) during inference, may keep the encoder size and memory constant regardless of the number of teachers, and, more importantly, it does not impact inference time. For DUNE 410, latter approach (or second option) is utilized by fine-tune the different heads and decoders. Fine-tuning decoders is a one-time operation and enables a more efficient inference.

After training the DUNE 410 (or the universal encoder), task-specific heads are then fine-tuned independently for each task, while keeping the DUNE 410 encoder frozen. Task-specific heads or decoders may include MASt3R head 135, multi-HMR head 130, DINO-v2 segmentation head 120, and DINO-v2 depth head 125.

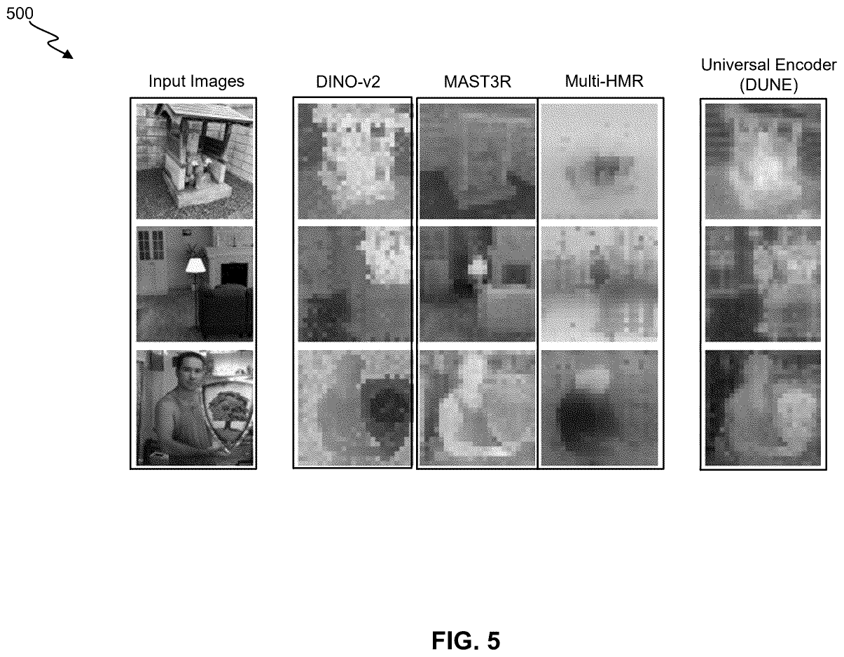

FIG. 5 illustrates a comparison of principal component analysis (PCA) visualization of encoder outputs of the teacher encoders 220a-n and the student encoder 110 in accordance with an example implementation of the present disclosure. For a given input image 210, patch features or embeddings can be extracted from the encoders of the teacher models and the student encoder 110. Three state-of-the-art models that are selected include two highly task-specific such as MAST3R that solves 3D scene reconstruction and matching, and multi-HMR that solves 3D human perception. The third teacher is DINO-v2, a popular visual foundation model known for its strong generalization across various downstream visual tasks. The selected teachers vary with respect to both the tasks they are tackling and the datasets they were trained on.

The dimensions of the embeddings can be reduced to 3 via PCA. The top three components (obtained via PCA) for the patch features of each teacher, as well as the features of the co-distilled encoder, i.e., DUNE 410 (or the student encoder 110) can be visualized in FIG. 5. Three randomly selected images from the Map-free and BEDLAM datasets are used as input images for the features visualization or analysis. Heterogeneity is clearly visible when inspecting the top three components obtained by the PCA for the features (output) of each encoder as well as the features (output) of the student encoder 110. Each teacher has distinct and complementary features and the disclosed universal encoder (or the student encoder 110) captures properties that are present across all teachers. The visualization reveals that patch similarity patterns differ across the teacher models, while our student model attempts to simultaneously capture and integrate multiple patterns from the different teachers.

### Examples

Example implementations of the disclosed techniques are provided to experimentally evaluate the multi-teacher distillation architecture as described in FIG. 2 and FIG. 3. A representative set of heterogeneous teacher models was selected for experimental validation. The first teacher model is DINO-v2 with registers, a self-supervised, task-agnostic model whose strong representations have been applied across various computer vision tasks. Additionally, two domain-specialized models were included: Multi-HMR, a model for human mesh recovery and winner of the Robin Challenge (see, https://rhobin-challenge.github.io) at Computer Vision and Pattern Recognition (CVPR′24) conference, and MASt3R, a 3D foundation model that achieved first place in the Map-free Visual Re-localization challenge at European conference on computer vision (ECCV′24). The selected teacher models span both 2D and 3D tasks, with the two 3D-oriented models differing in the nature of the 3D information they encode (e.g., SMPL parameters versus dense matches) and their encoding methods. For instance, Multi-HMR captures the full 3D human pose in a single patch token. All teacher models used in this implementation are based on the publicly available ViT-Large architecture.

A total of 19 publicly available datasets were used as sources for distillation data 205, comprising approximately 20.7 million images. These datasets were derived from the training sets of the respective teacher models. Specifically, the datasets includes ImageNet-19K (2021 release), Mapillary, and Google Landmarks v2 from DINO-v2; AGORA, BEDLAM, UBody, and CUFFS from Multi-HMR; and Habitat, ARKitScenes, Blended MVS, MegaDepth, ScanNet++, CO3D-v2, Map free, WildRgb, VirtualKitti, Unreal4K, TartanAir, and DL3DV from MASt3R. The image content from each dataset was used only, with all annotations were removed from the training of (or distilling) the student encoder 110.

The 19 datasets used for co-distillation are also listed in TABLE 1. The teacher column (right most) groups the datasets which are associated with each teacher. As indicated in TABLE 1, the datasets are unbalanced in size. To ensure balanced training, each training batch was constructed to include an equal number of randomly sampled images from the datasets associated with each teacher model, i.e., DINO-v2, Multi-HMR, and MASt3R.

TABLE 1
Datasets used for training DUNE models.

| Name | Size | Nature | Teacher |
|---|---|---|---|
| ImageNet-19K | 13,153,480 | Real | DINO-v2 |
| Mapillary | 1,205,907 | Real | |
| Google Landmarks v2 | 4,132,914 | Real | |
| Habitat | 284,968 | Rendered | MAST3R |
| ARKitScenes | 456,108 | Rendered | |
| Blended MVS | 98,937 | Rendered | |
| MegaDepth | 36,949 | Real | |
| ScanNet++ | 60,188 | Rendered | |
| CO3D-v2 | 185,100 | Real | |
| Map-free | 41,300 | Real | |
| WildRgb | 224,400 | Real | |
| VirtualKitti | 1,200 | Synthetic | |
| Unreal4K | 14,386 | Synthetic | |
| TartanAir | 136,225 | Real | |
| DL3DV | 208,800 | Rendered | |
| BEDLAM | 353,118 | Synthetic | Multi-HMR |
| AGORA | 14,314 | Synthetic | |
| CUFFS | 54,944 | Synthetic | |
| UBody | 54,234 | Real | |
| Total size: | 20,717,472 | | |

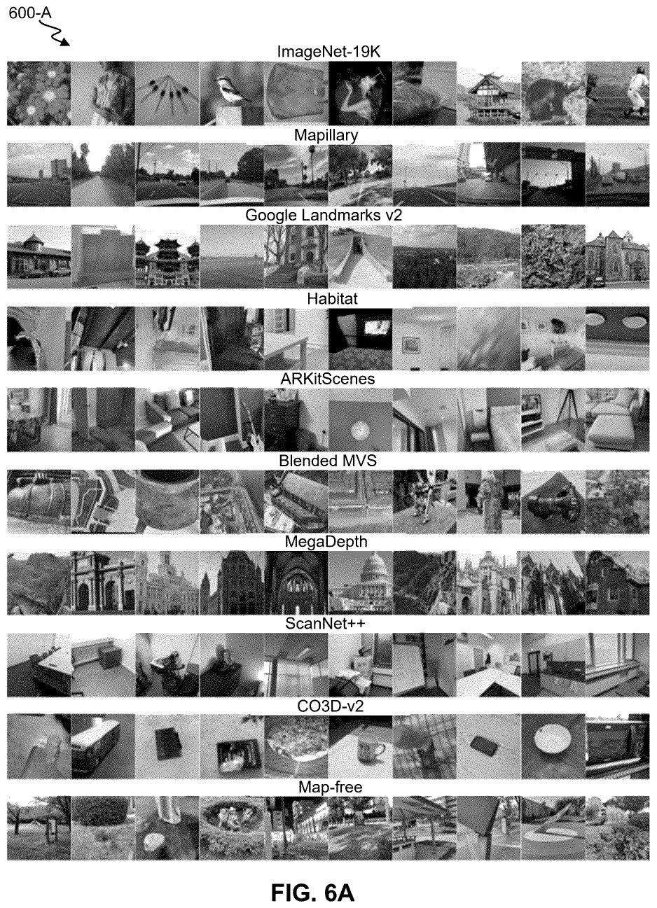

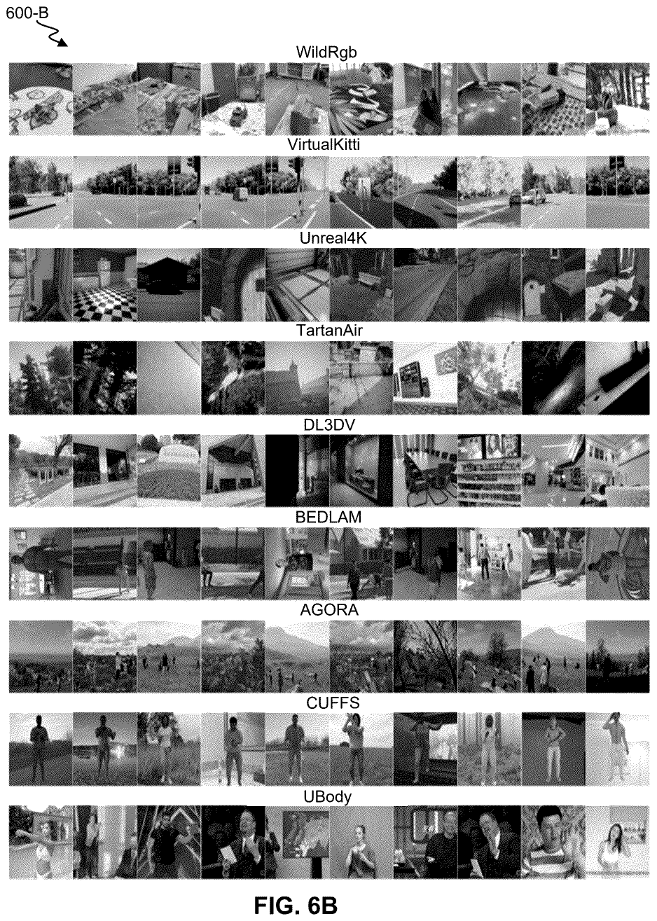

FIG. 6A shows visualization of random samples or images from 10 datasets out of 19 datasets that are used as distillation data 205 in accordance with an example implementation of the present disclosure. Ten randomly sampled images from the datasets listed in TABLE 1 are shown in FIG. 6A. Specifically, the datasets that are visualized in FIG. 6A include ImageNet-19K, Mapillary, and Google Landmarks v2 from DINO-v2 teacher; and Habitat, ARKitScenes, Blended MVS, MegaDepth, ScanNet++, CO3D-v2, Map free from MASt3R teacher.

FIG. 6B shows visualization of random samples or images from remaining 9 datasets out of 19 datasets that are used as distillation data 205 in accordance with an example implementation of the present disclosure. Nine randomly sampled images from the datasets listed in TABLE 1 are shown in FIG. 6B. Specifically, the datasets that are visualized in FIG. 6B include Habitat, WildRgb, VirtualKitti, Unreal4K, TartanAir, and DL3DV from MASt3R teacher; BEDLAM, AGORA, CUFFS, and UBody from Multi-HMR teacher.

For clarity of presentation and without loss of generality it can be assumed that the full datasets used to train each teacher model are also available for the distillation process. In practice, this assumption may fail due to limitations such as dataset size or public availability. In such instances, a subset of the data may be used, or alternative data sources spanning similar domains may be substituted. This consideration applies not only to distillation but also to datasets used in downstream finetuning.

During the distillation process, the student encoder 110 comprises a ViT-Base encoder along with three separate projector heads, one corresponding to each teacher model. Initial experiments employed the Ladder of Projectors (LP) architecture as described in FIG. 3. In addition, evaluations were also performed using the Transformer Projector configuration, as illustrated in FIG. 2 and FIG. 4A. Unless explicitly stated otherwise, projectors 215a-n are removed after the distillation process and are not involved during evaluation or inference. All distillation variants were trained under a fixed compute budget corresponding to the processing of 100×1,281,167 images, which equates to 100 training epochs on ImageNet-1K.

Data augmentation included random resized cropping to 224×224 pixels followed by random horizontal flipping, color jitter, grayscale transformation, Gaussian blur, and solarization. Unless stated otherwise, all student models employed ViT-Base architecture with a patch size of 14 and were trained for 100 epochs. Models utilizing teacher-dropping regularization were trained for 200 epochs. Notably, extending training duration alone yielded only marginal improvements in performance. Optimization was performed using AdamW with a learning rate of 3e-4, weight decay of 3e-2, and batch size of 512 distributed across four GPUs. A linear learning rate warmup was applied over the first 10 epochs, followed by a cosine decay schedule.

Unless stated otherwise, encoder distillation is performed using images with a resolution of 336×336. For some models, additional distillation runs are conducted at 448×448 resolution for a limited number of epochs. The resulting encoders are evaluated on tasks aligned with the domain expertise of the teacher models. For domain-specialized teachers, selected tasks include multi-person human mesh recovery for Multi-HMR and map-free visual relocalization for MASt3R. Evaluation on Multi-HMR is performed using the BEDLAM validation set, with metrics including F1-Score for detection and PA-PVE (point accuracy-point-to-vertex error) for mesh reconstruction errors. For MASt3R, the Area Under the Curve (AUC) metric is reported for samples with Virtual Correspondence Reprojection Error (VCRE) below a 90-pixel threshold on the validation set of the Map-free Visual Relocalization dataset. Additional evaluation tasks include multi-view depth estimation and multi-view camera pose regression. To assess generalization capability, the encoder is also evaluated on semantic segmentation using ADE20K (measured by mean Intersection over Union, mIoU) and depth estimation using NYUdv2 (measured by Root Mean Squared Error, RMSE), consistent with prior benchmarks.

The set of hyper-parameters and their values that were used for training the encoders, i.e., DUNE 410 models are given in TABLE 2. Further, as described in FIG. 3, for a given image x from the distillation data 205, the distillation process minimizes the combination of the cosine and smooth- [symbol] 1 losses between the outputs of student sᵢ=hᵢ (fᵢ(x)) and each teacher tᵢ=tᵢ(x):

$${ℒ}_{distil} = {\sum }_{i = 1}^{N} {ℒ}_{c o s} ( {s}_{i} , {t}_{i} ) + {ℒ}_{s l 1} ( {s}_{i} , {t}_{i} ) ,$$

$$where ,$$

$${ℒ}_{cos} ( s , t ) = 1 - \frac{s \cdot t}{{‖ s ‖}_{2} \times {‖ t ‖}_{2}} ,$$

$${ℒ}_{sl 1} ( s , t ) = \{ \begin{matrix}0.5 \times {‖ s - t ‖}_{2}^{2} , & for {‖ s - t ‖}_{1} < 1 , \\ {‖ s - t ‖}_{1} - 0.5 , & otherwise\end{matrix} .$$

TABLE 2
Hyper-parameters used for training DUNE models.

| Hyper-parameter | Value |
|---|---|
| Encoder | Architecture: ViT-Base |
| | Patch size: 14 |
| | Num. registers: 0 |
| | QKV bias: True |
| | LayerScale: True |
| | Path drop rate: 0 |
| Projector | Architecture: TP |
| | Num. blocks: 1 |
| | Block configuration follows encoder |
| Image resolution | Initial: 336 × 336 |
| | Fine-tuned: 448 × 448 |
| Batch size | 128 per GPU |
| Num. GPUs | 4 |
| Optimizer | Type: AdamW |
| | Weight decay: 3e−2 |
| | (β1, β2): (0.9, 0.99) |
| Learning rate | Min: 1e−6 |
| | Max: 3e−4 |
| | batch-size/256 |
| | Schedule: Cosine |
| Data type | AMP with bloat16 |
| Training data (Tab 1 | All (DUNE-20.7M, see Tab. 5) |
| in the main paper) | |
| Data sharing (Tab 2 in | Full data sharing |
| the main paper) | |
| Training budget | 1,281,167 × 100 images |

For domain-specialized tasks, the corresponding teacher's decoder module is attached to the frozen distilled encoder (e.g., DUNE 410), and the decoder is fine-tuned specifically for that task. In the case of semantic segmentation and depth estimation, a linear prediction head is trained from scratch and appended to the frozen encoder, following the approach of DINO-v2. For segmentation tasks, incorporating or re-using the frozen transformer projector associated with the DINO-v2 teacher prior to training the linear layer (or linear prediction head) led to notable performance improvements. For this case only, results are reported with the projector included.

The MASt3R model employs a binocular architecture that integrates a Siamese ViT-encoder to process input image pairs, followed by binocular decoders and a prediction head. During fine-tuning of MASt3R, its encoder is replaced with the distilled (student) encoder (or the universal encoder), which remains frozen throughout fine-tuning. Publicly available MASt3R code is utilized to maintain implementation consistency. Decoder and head modules are initialized using the released weights, while layers with dimensional mismatches are re-initialized. Specifically, mismatches are observed in the fully connected layer connecting the universal encoder to the MASt3R decoder (due to the ViT-Base encoder as used by the universal encoder is having a feature dimension of 768, in contrast to 1024 in ViT-Large encoder of the MASt3R), and in the output layer, which produces pixel-wise predictions, due to differences in patch size (e.g., 14 in the disclosed implementation versus 16 in the MASt3R). The model is fine-tuned on 6.5 million image pairs using the AdamW optimizer across multiple image resolutions. For encoders (e.g., DUNE 410) distilled at 336×336 resolution, the fine-tuning process utilized images with resolutions {448×448, 448×336, 448×294, 448×252, 448×224, 448×140}, which corresponds to the same number of patches as MASt3R's setting or configuration. For encoders (e.g., DUNE 410) that were further distilled at 448×448 resolution for some additional epochs, fine-tuning process utilized images with resolutions {518×518, 518×392, 518×336, 518×294, 518×252, 518×168}, selected to align with the MASt3R configuration and maintain compatibility with a 14-pixel patch size (i.e., multiples of 14).

To evaluate the distilled student encoder on the task of human mesh recovery (HMR), the training framework and publicly available codebase of Multi-HMR model are utilized. projector modules are discarded, and the weights of the distilled student encoder are kept frozen during training (or fine-tuning). The human perception head (HPH), as introduced in Multi-HMR, is used to predict mesh representations from the outputs of the backbone (i.e., DUNE 410 or distilled encoder). Two transformer blocks are prepended to the HPH, which is trained from scratch using the BEDLAM dataset with images at a resolution of 672×672. Training is performed with a learning rate of 4e-5, a batch size of 16, and a cosine learning rate decay schedule over 200,000 iterations. After training, evaluation is conducted on the BEDLAM validation set using a non-maximum suppression (NMS) kernel of size 3 and a detection threshold of 0.3, following the multi-HMR evaluation protocol. It is noted that this evaluation procedure favors the teacher model, as it operates at its native input resolution of 672× 672, while the student encoder is distilled at 448×448 resolution due to computational constraints.

Both semantic segmentation and depth estimation are treated as dense prediction tasks and framed as classification problems. These tasks are addressed following the methodology introduced in DINO-v2. Tokens (patch features) from the last output layer of the student encoder 110 are extracted and used as input to a linear prediction head. For semantic segmentation, the transformer projector (TP) from the DINO-v2 teacher is incorporated into the frozen encoder, and the linear prediction head is trained on top of the TP to produce class logits from a patch token. The resulting 32×32 logit map is then upsampled to a 512×512 resolution (the original image resolution) using bilinear interpolation. For depth estimation, patch features are first upsampled by a factor of four using bilinear interpolation and concatenated along the feature dimension with the CLS token. These combined features are then passed through the linear prediction head to generate depth predictions. Depth estimation is formulated as a soft classification task, employing 256 uniformly distributed depth bins.

TABLE 3
Distillation data and projector design.

| Distil. | Proj. | ADE20K | NYUd | MapFree | BEDLAM |
|---|---|---|---|---|---|
| Data | Design | (mIoU ↑) | (RMSE ↓) | (AUC ↑) | (PA-PVE ↓) |
| IN-19K | LP | 42.4 | 0.446 | 91.4 | 83.9 |
| IN-19K | TP | 44.9 | 0.433 | 93.6 | 73.5 |
| All | SP | 42.3 | 0.413 | 92.4 | 73.1 |
| All | LP | 44.7 | 0.384 | 91.5 | 78.2 |
| All | TP | 44.9 | 0.377 | 93.7 | 68.3 |

An initial set of experiments was conducted to determine whether a large-scale, generic dataset such as ImageNet-19K is good enough for distilling knowledge from heterogeneous teacher models. Two student models were trained using a sparsely-connected Ladder of Projectors (LP) configuration, in which a multi-layer perceptron is appended after every three encoder blocks (or layers). The first student model was trained exclusively with ImageNet-19K as the distillation data 205, while the second model used the full collection of 19 teacher datasets (of TABLE 1) with complete data sharing, as described in FIG. 2. By comparing rows 1 and 4 of TABLE 3, it can be observed that using additional specific data improves the performance of the student model on all the tasks by a decent margin. Afterwards, more student models were distilled by employing either the simple projector (SP), the ladder of projectors (LP), or the transformer projector (TP) as explained in the descriptions of FIG. 2 and FIG. 3. Results summarized in TABLE 3 demonstrate that using the combined teacher-specific datasets (full data sharing) yields consistent performance improvements across all evaluated tasks compared to using generic data alone.

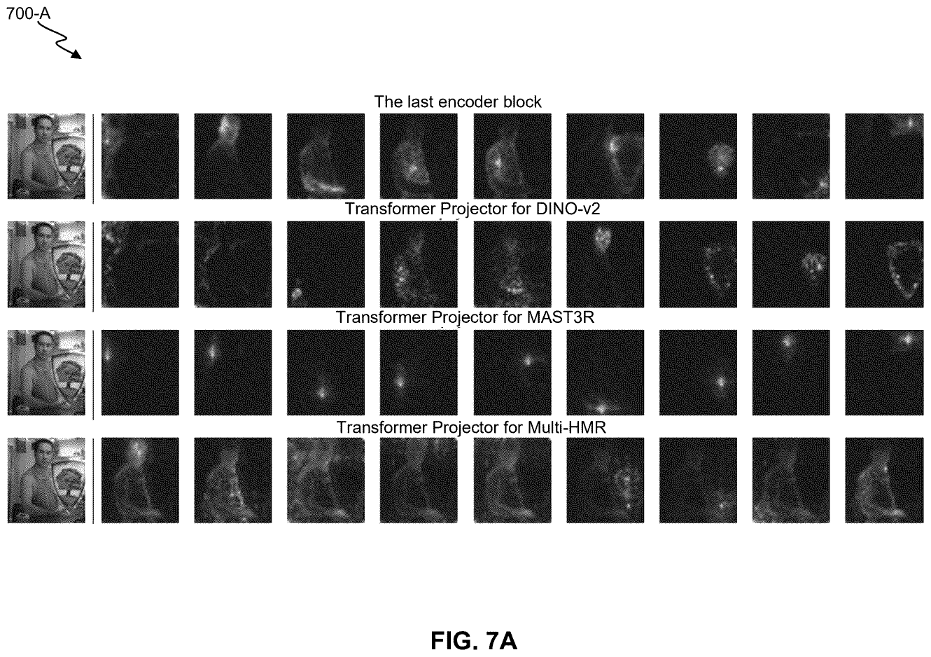

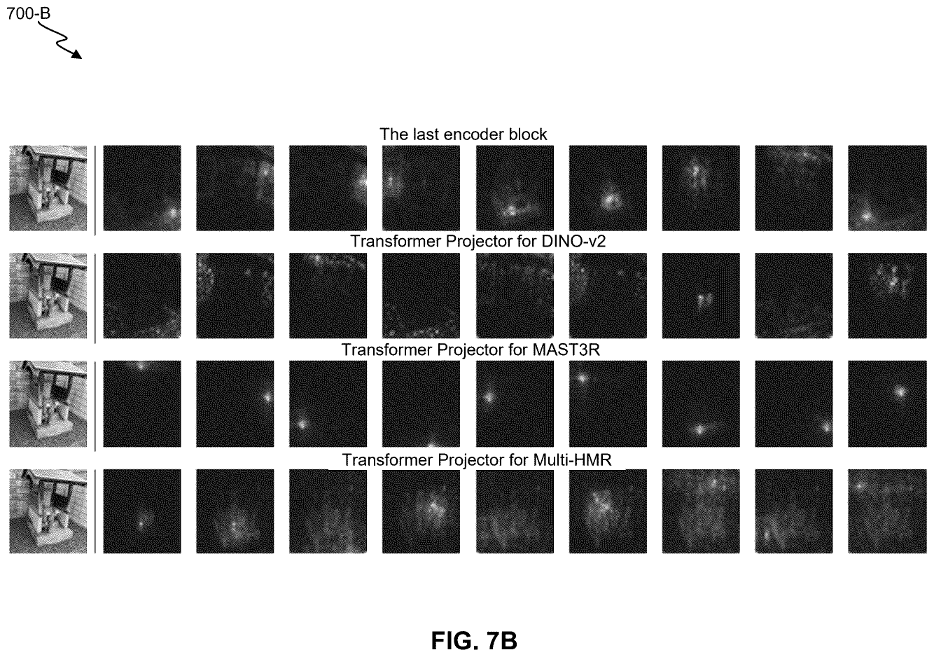

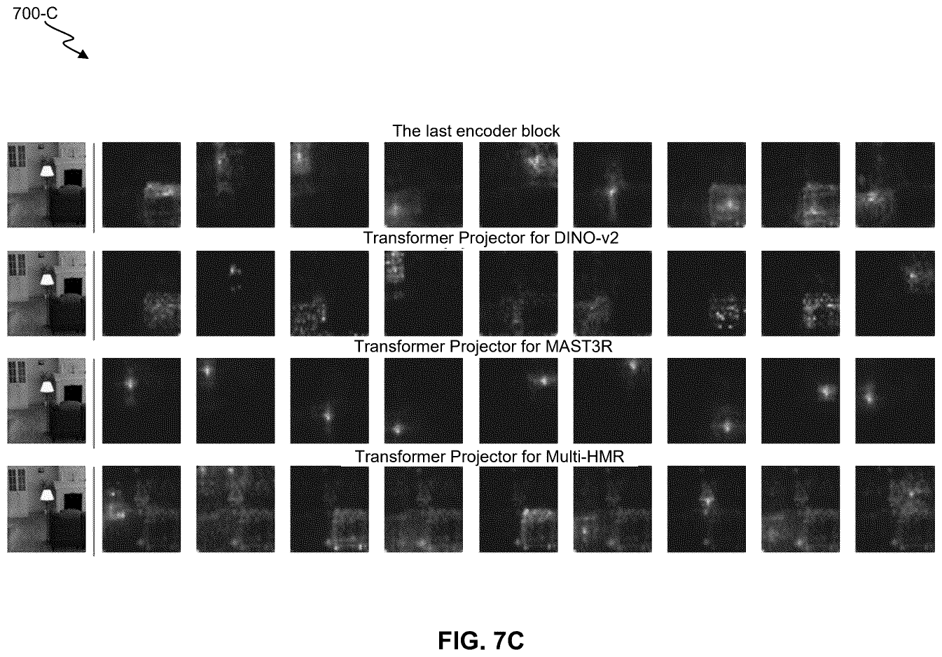

FIGS. 7A-7C show illustrative comparison of visualizations of attention maps that are extracted from the last layer of the distilled encoder and from the transformer projector of each teacher for a given input image 210. To investigate attention behavior during distillation, attention probabilities were visualized from the final encoder layer of the student model, along with those of the teacher-specific transformer projectors applied during training. Given an input image of 448×448 resolution (1st column of FIGS. 7A-7C), the student model generates a 32×32 attention map across 1,024 patches, corresponding to a patch size of 14 pixels. To identify representative attention behaviors, patch-wise attention maps were flattened and clustered using k-medoids clustering technique (with k=9), utilizing the implementation from Scikit-Learn (see, https://scikit-learn-extra.readthedocs.io/, which is hereby incorporated by reference in its entirety for all purposes). Distinct patterns can be observed between the final encoder block and the three transformer projectors corresponding to each teacher. The TP associated with MASt3R consistently produces highly localized attention, regardless of image content. In comparison, the TP for DINO-v2 generates spatially broader attention distributions. The TP for Multi-HMR tends to focus primarily on human figures when present in the scene (e.g., as in FIG. 7A).

Attention maps from the final encoder layer of the student model appear to reflect a synthesis of patterns observed in the three teacher-specific projectors. These include strong spatial locality resembling MASt3R, broad spatial coverage similar to DINO-v2, and a human-centric focus akin to Multi-HMR. This behavior suggests that the student encoder 110 learns to integrate diverse spatial characteristics during distillation. Moreover, as shown in FIG. 5, the spatial feature similarity patterns produced by different teacher encoders 220a-n are different from each other.

To address the variation in spatial feature characteristics across teachers, the transformer projector was evaluated as an alternative to LP-based configurations. For this purpose, the LP modules previously distributed throughout the encoder were replaced by a single TP module placed after the final encoder layer. Comparative evaluations, presented in TABLE 4, show that the TP design outperforms both the LP and the SP approaches across all tested tasks.

TABLE 4
Impact of data sharing across teacher projectors.

| | ADE20K | NYUd | MapFree | BEDLAM |
|---|---|---|---|---|
| Data Sharing | (mIoU ↑) | (RMSE ↓) | (AUC ↑) | (PA-PVE ↓) |
| No data sharing | 41.6 | 0.426 | 93.2 | 68.7 |
| Generic data sharing | 40.1 | 0.416 | 92.7 | 71.7 |
| Full data sharing | 44.9 | 0.377 | 93.7 | 68.3 |

Three data-sharing strategies were evaluated during co-distillation with all 19 datasets: (1) No data sharing, where each teacher uses exclusive datasets; (2) Generic data sharing, where ImageNet-19K is shared among all teachers; and (3) Full data sharing, where all images are accessible to all teachers. As shown in TABLE 4, the full data sharing strategy results in the highest overall performance across multiple diverse tasks, indicating that domain gaps between datasets do not hinder the ability of teachers to provide informative supervision on out-of-domain samples. Notably, in the case of semantic segmentation, results are shown for the student encoder 110 with the TP associated with the DINO-v2. If the TP projector is dropped at inference, the best results for the case of semantic segmentation are obtained when only generic data is shared. This suggests that semantic structures are better retained in the student encoder 110 when ImageNet-19K is made available to both MASt3R and Multi-HMR.

TABLE 5
Performance across 2D vision, 3D human understanding, and
3D vison tasks with the universal encoder (DUNE 410).

| | | | | | | | | |
|---|---|---|---|---|---|---|---|---|
| | Encoder | Training | Training | ADE20k | NYUd | BEDLAM | BEDLAM | MapFree |
| Model | Arch. | Data | Res. | (mIoU ↑) | (RMSE ↓) | (F1-score ↑) | (PA-PVE ↓) | (AUC ↑) |

Teacher Models

| | | | | | | | | |
|---|---|---|---|---|---|---|---|---|
| DINO-v2 | ViT-L | LVD-142M | 518 | 47.7 | 0.384 | — | — | — |
| Multi-HMR | ViT-L | HMR-500K | 672 | — | — | 95 | 36.9 | — |
| MASt3R | ViT-L | MASt3R-1.7M | 512 | — | — | — | — | 91.2 |

State of the Art ViT Encoders.

| | | | | | | | | |
|---|---|---|---|---|---|---|---|---|
| DINO-v2 | ViT-B | LVD-142M | 518 | 47.3 | 0.399 | 86 | 76.5 | 89.6 |
| AM-RADIO-v2.5 | ViT-B | DataComp-1B | 512 | 50 | 0.718 | 89 | 83.2 | 93.1 |
| DUNE | ViT-B | DUNE-20.7M | 336 | 44.9 | 0.377 | 91 | 68.3 | 93.7 |
| DUNE | ViT-B | DUNE-20.7M | 448 | 45.6 | 0.358 | 94 | 56 | 94.7 |

TABLE 5 provides a comparison of the distilled encoder (DUNE 410 or the universal encoder) with state-of-the-art teacher models. The top section of TABLE 5 reports the performance of the individual teacher models, where each teacher encoder is based on a ViT-Large backbone. The middle section presents a comparison of the distilled encoder with two strong ViT-Base alternatives: DINO-v2 and AM-RADIO-v2.5. For both models (DINO-v2 and AM-RADIO-v2.5), the decoder heads were fine-tuned for each evaluation task using the same procedure as for the disclosed encoder (e.g., DUNE 410). Co-distillation was conducted using DUNE-20.7M, i.e., the full set of 19 public datasets from TABLE 1. Results indicate that the distilled encoder (DUNE 410) outperforms both ViT-Base alternatives (DINO-v2 and AM-RADIO-v2.5) on all evaluation tasks, with the exception of semantic segmentation, where AM-RADIO-v2.5 achieves superior performance. This outcome is consistent with expectations, as AM-RADIO-v2.5 is distilled from semantically rich teacher models including CLIP, OpenCLIP, and the segmentation-oriented SAM.

TABLE 6
Results on the map-free visual relocalization official leaderboard.

| | | | | | | Median | Relative Pose Error | | |
|---|---|---|---|---|---|---|---|---|---|
| | | VCRE < 45px | | VCRE < 90px | | Reproj. | Median | | |
| Method | Encoder | AUC ↑ | Prec. ↑ | AUC ↑ | Prec. ↑ | Error (px) ↓ | Error ↓ | Prec. ↑ | AUC ↑ |
| LoFTR | CNN | 39.7 | 18.2 | 61.8 | 33.5 | 166.8 | 2.31 m 39.4° | 26.9 | 9.8 |
| DUSt3R | ViT-L | 45.9 | 28.7 | 69.8 | 50.4 | 115.8 | 0.99 m 7.1° | 39.4 | 21.4 |
| Mickey | ViT-L | 57.2 | 31.2 | 74.8 | 49.3 | 129.5 | 1.59 m 26.0° | 28.3 | 12 |
| MASt3R | ViT-L | 81.7 | 63 | 93.3 | 79.3 | 48.8 | 0.37 m 2.2° | 74 | 54.7 |
| DUNE | ViT-B | 84 | 64.4 | 94.3 | 81.1 | 47.4 | 0.39 m 4.6° | 76.8 | 55.9 |

TABLE 6 presents results obtained from the official leaderboard of the Map-free Visual Relocalization dataset (see, https://research.nianticlabs.com/mapfree-reloc-benchmark, which is hereby incorporated by reference for all purposes). Evaluation metrics include Area Under the Curve (AUC) and Precision (Prec.), both reported as percentages. The leaderboard entry for MASt3R corresponds to a private model version that demonstrates marginally better performance than the publicly released version utilized as a teacher in this implementation. On this benchmark, MASt3R was previously shown to significantly surpass the performance of earlier methods LoFTR, DUSt3R, and Mickey. All of these earlier models, including MASt3R employed a ViT-Large encoder backbone. Notably, when the ViT-Large encoder in MASt3R is substituted with the frozen ViT-Base encoder (i.e., DUNE 410 obtained via disclosed heterogenous teacher distillation architecture), and the MASt3R decoder is subsequently fine-tuned, the resulting model achieves even higher performance than the original MASt3R configuration. This result is achieved despite the student encoder 110 being substantially smaller, indicating the effectiveness of the disclosed distillation process.

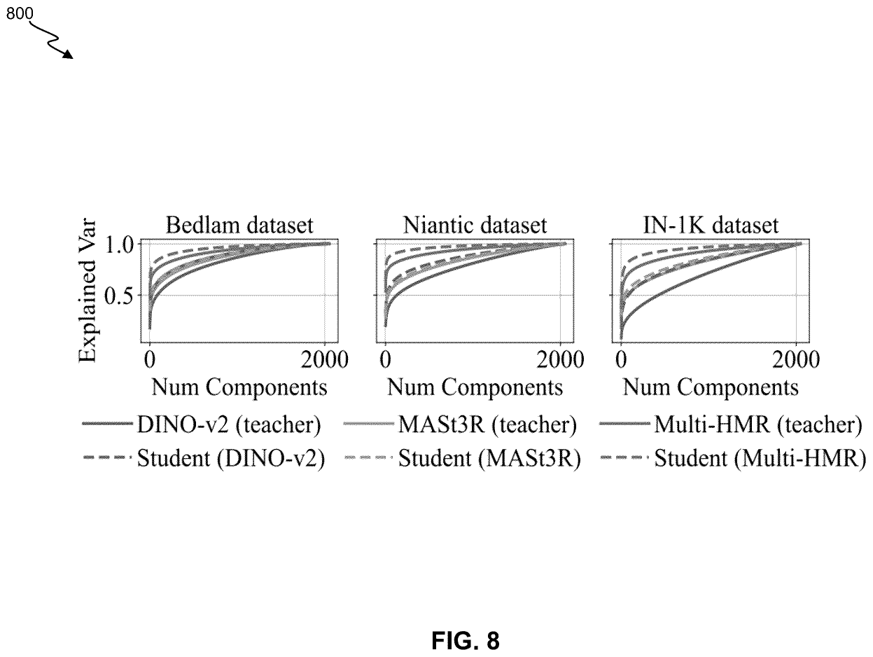

FIG. 8 illustrates cumulative explained variance that is computed over features from three representative datasets, for the three teacher encoders (solid lines) and student's projectors (dashed lines) in accordance with an example implementation of the present disclosure. FIG. 8 presents the cumulative explained variance, which represents the proportion of the dataset's variance cumulatively explained by each additional PCA component. Curves are shown for three representative datasets, comparing features from the teacher encoders with the corresponding student projector features. The three representative datasets correspond to Bedlam dataset, Niantic dataset, ImageNet-1k (IN-1k). Rather than exhibiting significant changes across datasets, a consistent difference in feature compactness is observed across teacher models. The Multi-HMR teacher consistently needs fewer PCA components to explain its feature variance, while DINO-v2 needs the most. This behavior may be attributed to the more specialized task and training data associated with Multi-HMR, in contrast to DINO-v2, which is trained on a more diverse dataset designed to function as a versatile encoder. The MASt3R model appears to fall between these two extremes, functioning as a versatile encoder with specialization in 3D tasks.

In the same figure, the explained variance curves are also shown for the features of the learned encoder after the application of teacher-specific heads, across the same three datasets. The explained variance curves based on the output of each of the teacher-specific heads follow the ranking of the corresponding teacher features, while the student representations are consistently more compact than those of the respective teachers.

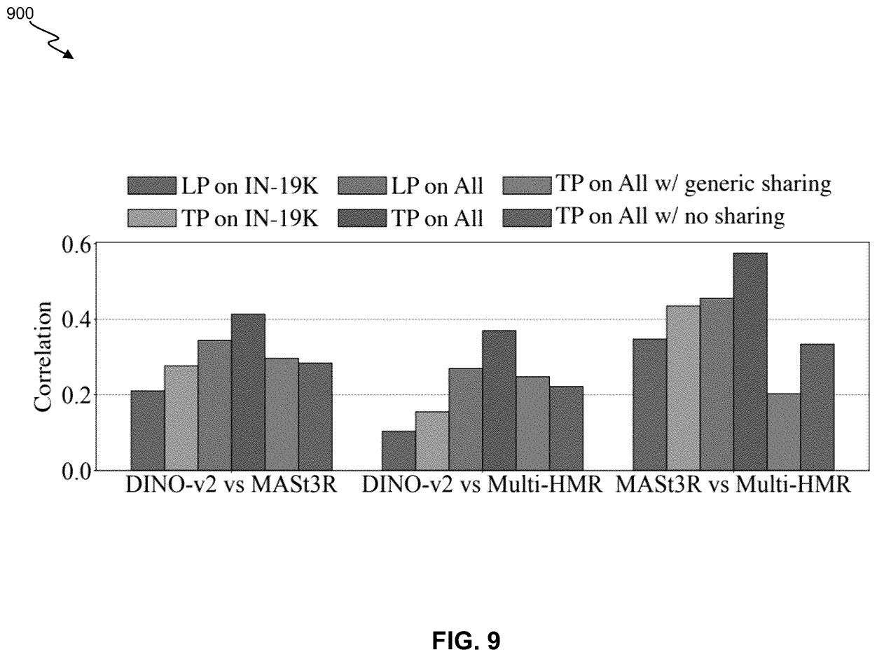

FIG. 9 illustrates the correlation of loss updates during training for each pair of teacher models, comparing different projector designs and data-sharing strategies, in accordance with an example implementation of the present disclosure. The frequency with which loss updates are correlated for three pairs of teacher models is shown in FIG. 9. Specifically, the correlation is measured based on the change in loss magnitudes after each weight update, capturing the alignment of loss fluctuations between teacher models. A strong positive correlation is indicative of high alignment (e.g., minimizing the loss for Multi-HMR also reduces the loss for DINO-v2), whereas a low correlation suggests that teacher feedback is less aligned, potentially leading to unstable training dynamics.

The first four bars in FIG. 9 correspond to two training data configurations (ImageNet-19K and the full set of 19 datasets) and two projector designs. It is observed that the use of LP consistently results in lower teacher alignment compared to TP, regardless of the training data. This lower alignment may account for the inferior performance of LP, particularly on specialized tasks, as demonstrated in TABLE 3. For the TP setup, teacher alignment is further measured across the three data-sharing configurations introduced in the description of FIG. 2 (rightmost three bars). Among all configurations, training all teachers on all datasets yields the highest correlation across all teacher pairs, a result that corresponds with the improved performance reported in TABLE 3.

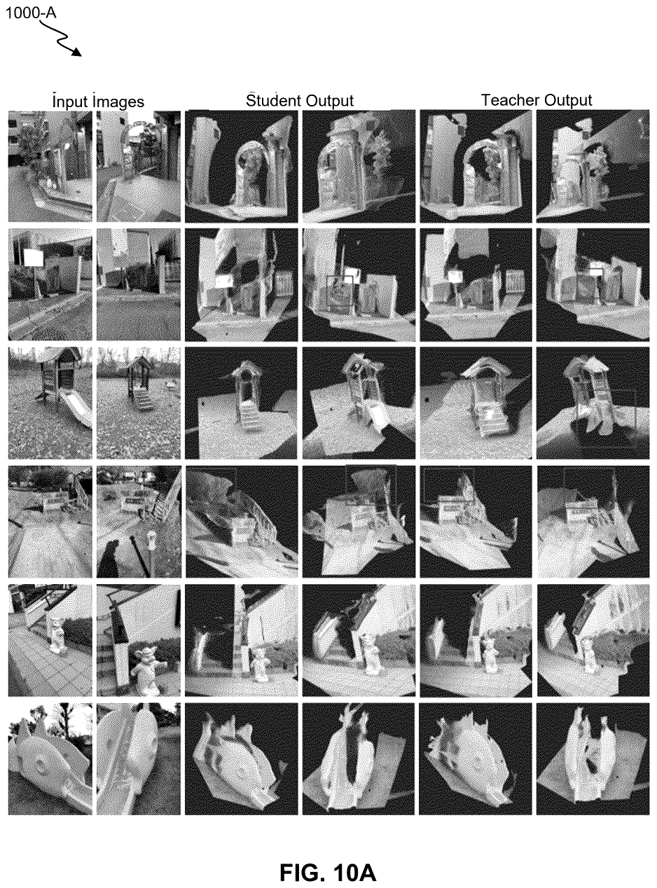

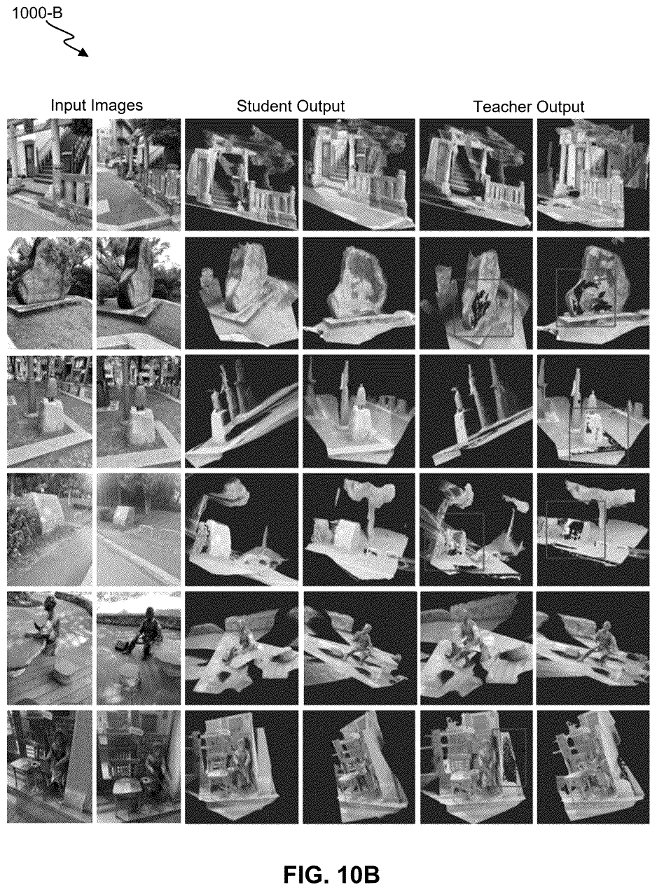

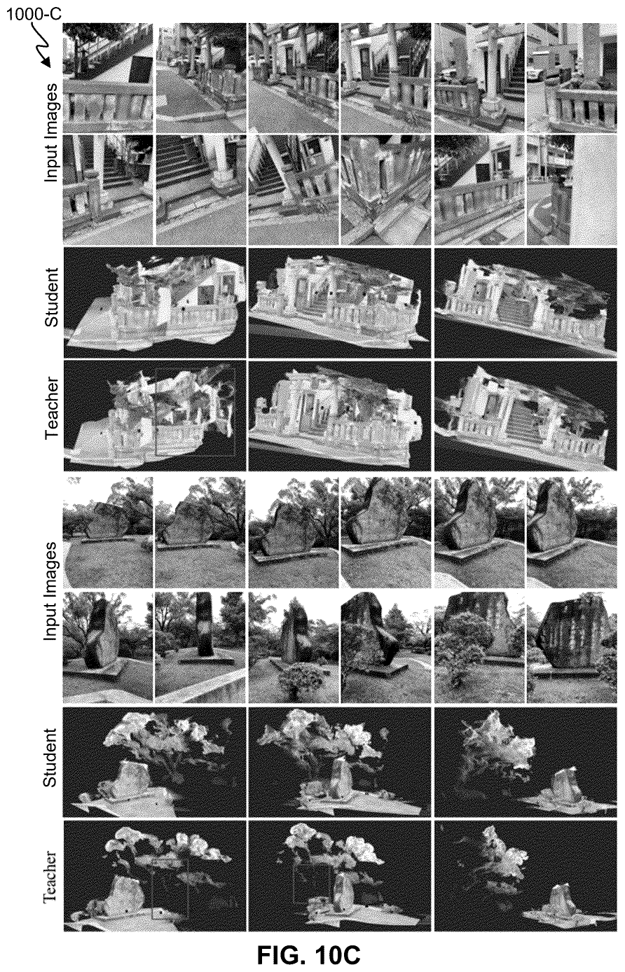

FIGS. 10A-10C illustrate side-by-side qualitative comparisons of 3D reconstruction results for the MASt3R teacher and the DUNE 410 student model, in accordance with an example implementation of the present disclosure. Input images are drawn from the Niantic dataset, and red squares highlight regions where the student appears to outperform the teacher. FIGS. 10A-10C present qualitative comparisons of 3D reconstruction performance between the MASt3R teacher and the disclosed DUNE 410 student model.

Each example of FIG. 10A and FIG. 10B includes two input images and the corresponding 3D reconstructions produced by the models. Each example in FIG. 10C includes four input images (or longer input sequence) and illustrates two corresponding 3D reconstructions produced by the models.

The qualitative results indicate that the student model demonstrates improved reconstruction fidelity over the teacher in several instances. This performance enhancement is visually apparent in specific regions of the output, which are highlighted with red squares in the figures.

These reconstructions, sampled from the Niantic dataset, demonstrate that the disclosed encoder, when paired with a suitable task decoder, is capable of producing outputs comparable to or better than those of the MASt3R teacher. FIG. 10C additionally shows scene reconstructions from longer input sequences, further highlighting regions where the student model achieves superior results.

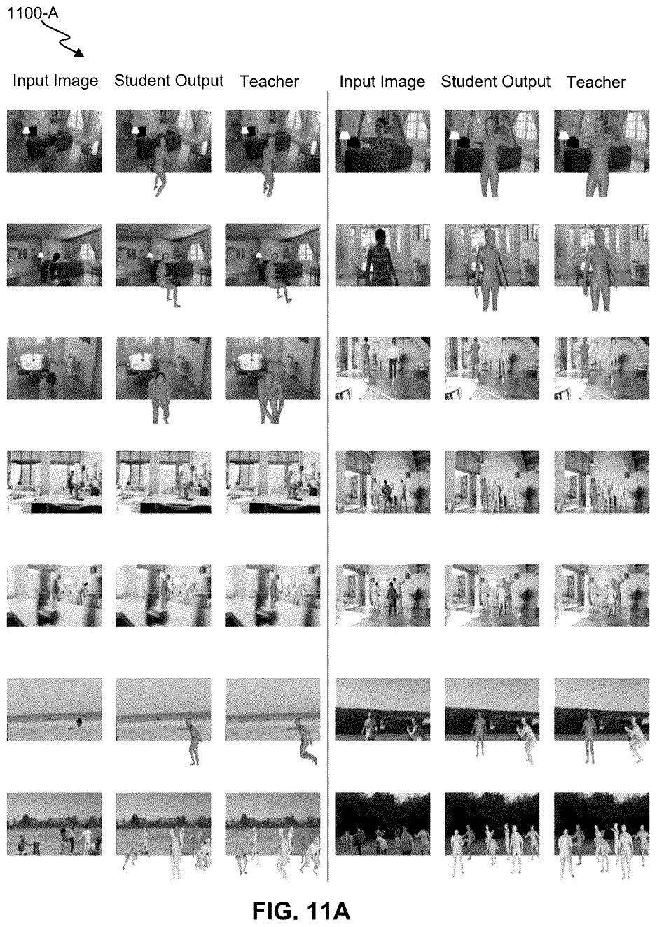

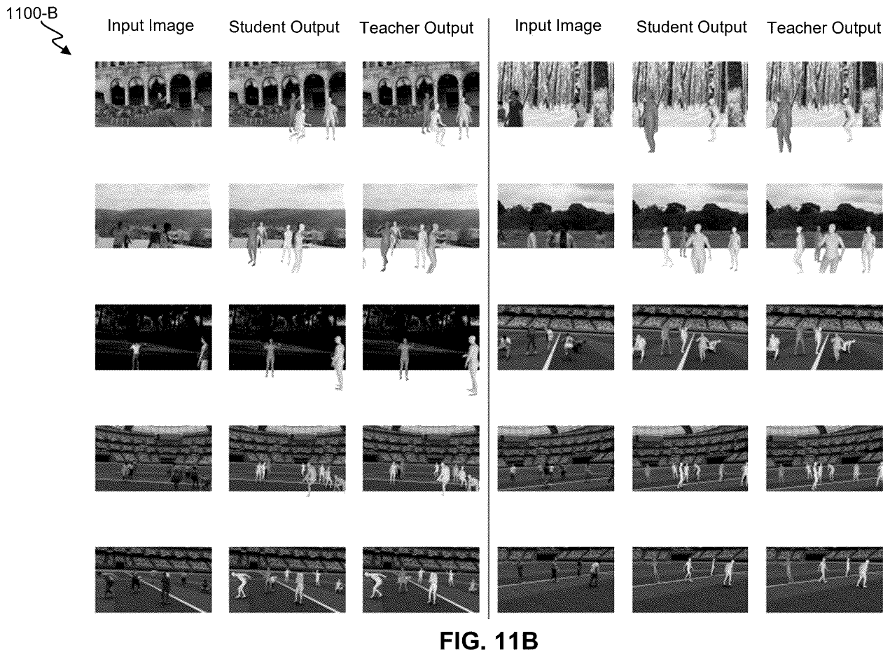

FIGS. 11A-11B illustrate qualitative comparisons of human mesh recovery results between the Multi-HMR teacher model and the DUNE 410 student model, based on images sampled from the BEDLAM validation set, in accordance with an example implementation of the present disclosure. The outputs of both models exhibit comparable visual quality.

The qualitative comparisons of human mesh recovery outputs from the Multi-HMR teacher and the disclosed DUNE 410 student model are presented in FIGS. 11A-11B. The images are randomly selected from the BEDLAM validation set and arranged in alphabetical order.

Across the examples, both the teacher and student models produce visually similar mesh recovery results. No substantial visual degradation is observed in the student outputs, indicating that the disclosed encoder, when paired with the appropriate task decoder, can replicate the performance of the teacher model in this task. The consistency in visual quality further supports the effectiveness of the proposed multi-teacher learning framework in transferring capabilities for human mesh recovery tasks.

Further, additional experimental evaluations are also provided for the disclosed DUNE 410 models. The additional results encompass tasks such as multi-view depth estimation, camera pose regression, semantic segmentation on additional datasets, and comparative performance against 2D-to-3D distillation baselines. Furthermore, evaluation results of DUNE 410 models are also provided on Feat2GS, a recent benchmark designed to assess 3D geometric and texture awareness through novel view synthesis.

For the multi-view depth estimation task, the evaluation protocol follows prior work (see, A benchmark and a baseline for robust multi-view dept estimation, Proc. 3DV, 2022, which is hereby incorporated by reference in its entirety for all purposes) and is applied across five benchmark datasets: KITTI, DTU, ETH3D, Tanks and Temples, and ScanNet. Two standard metrics are used to assess performance: the Absolute Relative Error (rel) and the Inlier Ratio (t), with a threshold of 1.03 on each test set. TABLE 7 presents multi-view depth estimation results for the DUNE 410 model and prior art baselines, reporting absolute relative error and inlier ratio across multiple test sets. The final column reports the average performance across all test sets. In TABLE 7, bold value in each column represents the best result and the underlined value represents the second-best result. Depth predictions for each image are extracted by computing the z-coordinate of the predicted pointmaps, following the procedure used in DUSt3R. When multiple pointmaps are available for a single image from different pairs, predicted depthmaps are rescaled and averaged using weights based on the predicted confidence values.

Notably, DeepV2D uses ScanNet during training, which contributes to its higher performance on that dataset. DUNE 410 employs a ViT-Base encoder, whereas MASt3R and DUSt3R utilize ViT-Large encoders. As shown in TABLE 7, the disclosed DUNE 410 model achieves performance comparable to both MASt3R and DUSt3R on multi-view depth estimation tasks, despite employing a smaller ViT-Base encoder, in contrast to the ViT-Large encoders used by MASt3R and DUSt3R.

TABLE 7
Multi-view depth evaluation with the absolute relative error (rel) and the inlier ratio (τ) on several test sets.

| | | KITTI | | ScanNet | | ETH3D | | DTU | | T&T | | Average | |
|---|---|---|---|---|---|---|---|---|---|---|---|---|---|
| Method | Encoder | rel. ↓ | τ ↑ | rel. ↓ | τ ↑ | rel. ↓ | τ ↑ | rel. ↓ | τ ↑ | rel. ↓ | τ ↑ | rel. ↓ | τ ↑ |
| Deep V2D | Hourglass | 10.00 | 36.20 | 4.40 | 54.80 | 11.80 | 29.30 | 7.70 | 33.00 | 8.90 | 46.40 | 8.60 | 39.90 |
| DUSt3R | ViT-Large | 5.88 | 47.67 | 3.01 | 72.54 | 3.04 | 75.17 | 2.92 | 73.94 | 2.93 | 78.51 | 3.56 | 69.56 |
| MASt3R | ViT-Large | 3.54 | 65.68 | 4.17 | 65.22 | 2.44 | 82.77 | 3.46 | 66.89 | 2.04 | 87.88 | 3.13 | 73.69 |
| DUNE | ViT-Base | 4.88 | 50.76 | 4.24 | 59.68 | 2.48 | 77.97 | 2.69 | 75.63 | 2.60 | 79.19 | 3.38 | 68.65 |

Multi-view camera pose regression evaluation was conducted following established protocols as in MASt3R to assess the performance of the disclosed DUNE 410 model. The evaluation was performed on the CO3Dv2 and RealEstate10K datasets using image sequences consisting of 10 frames. For each image pair, feature matches were obtained from the MASt3R decoder and head, and subsequently used to estimate essential matrices and compute the relative camera pose.

The performance metrics include Relative Rotation Accuracy (RRA) and Relative Translation Accuracy (RTA), evaluated at a 15° threshold. Additionally, the mean Average Accuracy (mAA30) is reported, which corresponds to the area under the accuracy curve for angular differences (RRA@30, RTA@30). The results are presented in TABLE 8.

As shown in TABLE 8, the disclosed DUNE 410 model demonstrates performance comparable to DUSt3R and MASt3R on the object-centric CO3Dv2 dataset. Notably, on the more challenging RealEstate10K dataset, DUNE 410 outperforms both baselines. These results are achieved despite DUNE 410 utilizing a ViT-Base encoder, whereas DUSt3R and MASt3R rely on larger ViT-Large encoders.

TABLE 8
Multi-view pose regression evaluation on the CO3Dv2
and RealEstate10K datasets with 10 random frames.

| | | | Co3Dv2↑ | | RealEstate10K↑ |
|---|---|---|---|---|---|
| Method | Encoder | RRA @ 15 | RTA @ 15 | mAA(30) | mAA(30) |
| DUSt3R | ViT-Large | 93.3 | 88.4 | 77.2 | 61.2 |
| MASt3R | ViT-Large | 94.6 | 91.9 | 81.8 | 76.4 |
| DUNE | ViT-Base | 92.2 | 90.7 | 78.8 | 79.9 |

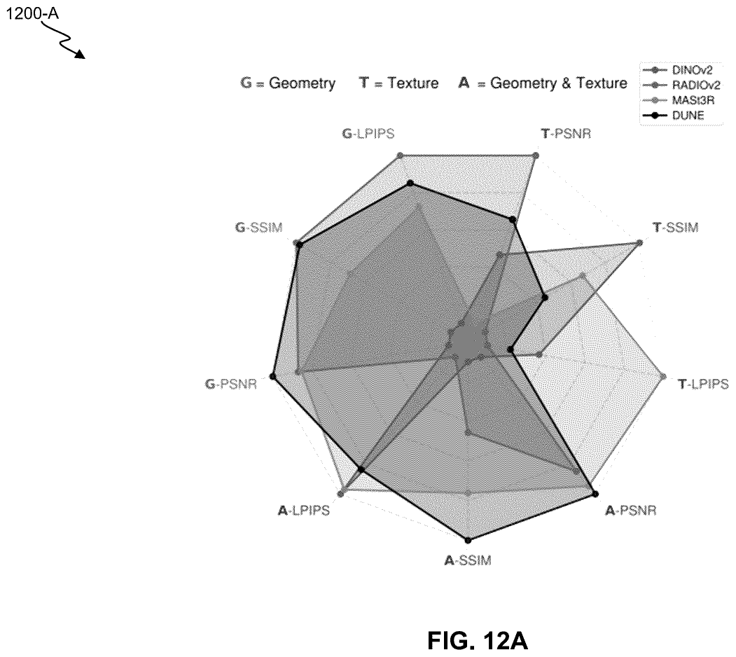

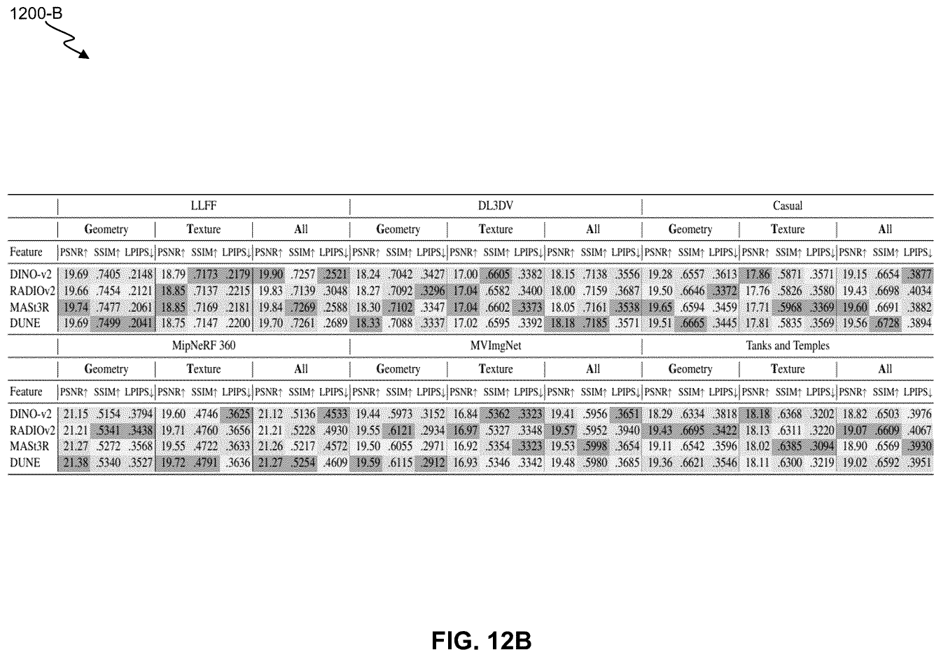

FIG. 12A illustrates a spider plot comparing different encoder models on the Feat2GS benchmark in accordance with an example implementation of the present disclosure. The Feat2GS benchmark evaluates novel view synthesis as a proxy for 3D awareness. The Feat2GS benchmark assesses a model's 3D awareness through its ability to perform novel view synthesis. The evaluation covers three modalities: (i) Geometry, where only geometry parameters are predicted from encoder features while texture is optimized freely for novel view synthesis; (ii) Texture, where only the texture is predicted and geometry is optimized freely; and (iii) All, where both geometry and texture are predicted from encoder features. In the spider plot, a larger distance from the center indicates stronger performance.

The disclosed DUNE 410 model achieves the strongest performance when both geometry and texture are predicted from features—the most challenging modality—demonstrating superior generalization and 3D understanding. Among all models, DUNE 410 also attains the largest overall area across all metrics and modalities in the spider plot. The comparison includes encoders of varying architecture sizes: RADIOv2 is based on a ViT-H backbone, MASt3R uses ViT-L, and both DINO-v2 and DUNE 410 are built on ViT-B. Notably, despite using a smaller ViT-B encoder, DUNE 410 outperforms several larger models, further underscoring the efficiency and effectiveness of the disclosed co-distillation architecture.

FIG. 12B illustrates per-dataset quantitative evaluation results for various encoder models—DINO-v2, RADIOv2, MASt3R, and DUNE 410—on the Feat2GS benchmark, in accordance with an example implementation of the present disclosure. Performance is measured under three modalities: geometry-only, texture-only, and combined (all), using peak signal-to-noise ratio (PSNR), structural similarity index measure (SSIM), and learned perceptual image patch similarity (LPIPS) metrics across six datasets. The results demonstrate that DUNE 410 achieves competitive or superior performance compared to larger models, particularly when predicting both geometry and texture.

FIG. 12B presents a comprehensive evaluation of different encoder models on the Feat2GS benchmark across six datasets: LLFF, DL3DV, Casual, MipNeRF 360, MVImgNet, and Tanks and Temples. For each dataset, the models are assessed under three evaluation settings—Geometry, Texture, and All—reflecting different combinations of predicted parameters for novel view synthesis (geometry-only, texture-only, and both, respectively). Within each setting, three image quality metrics are reported i.e., peak signal-to-noise ratio (PSNR1), structural similarity index measure (SSIM1), and learned perceptual image patch similarity (LPIPS1). Arrows indicate the direction of desirable metric values. Higher PSNR and SSIM, and lower LPIPS, indicate better performance.

The compared encoders include DINO-v2 (ViT-B), RADIOv2 (ViT-H), MASt3R (ViT-L), and the proposed DUNE 410 (ViT-B). Despite being based on a smaller ViT-B architecture, DUNE 410 consistently achieves top or near-top performance across multiple datasets and evaluation configurations. Notably, DUNE 410 outperforms RADIOv2 and MASt3R—both based on larger ViT models—on several benchmarks, especially under the ‘All’ prediction modality which combines geometry and texture estimation. The results underscore DUNE's capacity for efficient and accurate 3D-aware representation learning.

TABLE 9 presents semantic segmentation evaluation results on three datasets, comparing the disclosed DUNE 410 model to Pri3D, a representative 3D-to-2D distillation method, and to the MASt3R teacher. As previously described, segmentation performance can be enhanced by incorporating the DINO-v2 teacher projector as part of the frozen encoder and training a linear classifier on top. Accordingly, two versions of the DUNE 410 model are evaluated: one that uses the encoder outputs directly, referred to as DUNE (no proj.), and one that includes the DINO-v2 projector, referred to as DUNE. In both configurations, only a linear classification layer is trained to predict patch-level semantic labels. Across all datasets, both versions of DUNE 410 outperform Pri3D and MASt3R, demonstrating the superior generalization and representation capabilities of the disclosed encoder.

TABLE 9
Additional semantic segmentation evaluations.

| | Cityscapes | NYUv2 | ScanNet | Avg. |
|---|---|---|---|---|
| Model | (mIoU↑) | (mIoU↑) | (mIoU↑) | (mIoU↑) |
| Pri3D | 56.3 | 54.8 | 61.7 | 57.6 |
| MASt3R | 58.9 | 60.2 | 57 | 58.7 |
| DUNE (no proj.) | 65.6 | 66.1 | 61.2 | 64.3 |
| DUNE | 70.6 | 68.2 | 65.2 | 68 |

TABLE 10 presents depth estimation performance on the NYUv2 dataset, comparing the disclosed DUNE 410 model to FiT-3D, a recent approach designed to enhance DINO-v2 features for 3D understanding tasks. The disclosed DUNE 410 encoder achieves substantially improved results over FiT-3D, further highlighting its effectiveness for 3D perception applications.

TABLE 10
Comparison to Fit-3D on monocular depth.

| | NYUv2 |
|---|---|
| Model | (RMSE ↓) |
| FiT-3D | 0.38 |
| DUNE | 0.358 |

The present disclosure discloses a multi-teacher distillation architecture specifically designed to address the challenges of multi-teacher distillation where the set of teacher models is highly heterogeneous in nature. The disclosed method effectively distills knowledge from both general-purpose encoders, such as DINO-v2, and specialized models like Multi-HMR and MASt3R, each trained on distinct tasks and data domains. Through this unified distillation process, a single universal encoder (or the student encoder 110), referred to as DUNE 410, is learned to capture and integrate complementary strengths from all teachers.

The resulting DUNE 410 encoder exhibits strong generalization across a wide range of 2D and 3D visual tasks. When paired with the task-specific decoders of its respective teachers, DUNE 410 matches or surpasses the original models' performance, despite using significantly fewer parameters. Notably, it achieves superior results on demanding benchmarks such as Map-free Visual Relocalization, outperforming even highly specialized models like MASt3R. Furthermore, DUNE's design supports modular deployment, maintaining compatibility with existing decoders without the need for re-training, making it a practical and efficient solution for multi-task visual understanding. This disclosed approach therefore provides a scalable and effective technique of transferring diverse capabilities into a unified, compact, and high-performing representation.

In other example implementations, the disclosed multi-teacher distillation architecture was employed to distill from task-agnostic or non-heterogeneous teachers. These included ViT-Base models pretrained on the ImageNet dataset, such as DINO, DeiT-III, iBOT, and dBOT-ft, as well as larger vision foundation models including DINO-v2 and MetaCLIP, trained on generic or arbitrarily curated datasets. Using the disclosed techniques—such as a ladder of projectors, teacher dropping, and feature standardization—distilled encoders were learned from two or more ViT encoders. The resulting encoders retained or exceeded the performance of the strongest teacher across a range of tasks. These distilled encoders are referred to herein as universal classification models, or UNIC, representing encoders distilled from vision foundation models using the disclosed multi-teacher architecture. Such encoders demonstrated strong generalization capabilities across a broad spectrum of image classification tasks.

To isolate the contributions of various distillation components, identical training data and model architecture were used for all teacher and student encoders. Specifically, training was conducted using the ImageNet-1K dataset and ViT-Base architecture. During distillation, class labels from ImageNet were disregarded, and only image inputs were utilized; no supervised classification loss was introduced, relying solely on the distillation losses described in the foregoing.

The teacher models used in this example included both self-supervised representations, such as DINO and iBOT, and supervised models, including DeiT-III and fine-tuned dBOT. Self-supervised models had demonstrated strong generalization across domains, while supervised models achieved state-of-the-art accuracy on ImageNet-1K. The present example focused on distillation from two teachers—DINO and DeiT-III—with additional teacher combinations addressed in later examples.

Performance of the resulting universal encoder was evaluated across a wide range of tasks: (i) Top-1 accuracy on the ImageNet-1K validation set (IN-val); (ii) average Top-1 accuracy across 15 diverse image classification datasets for transfer learning; (iii) semantic segmentation performance measured using metric mIoU on the ADE-20K dataset; and (iv) depth estimation performance evaluated via metric RMSE on the NYUv2 dataset. All tasks were formulated as classification tasks using linear probes attached directly to frozen encoder outputs z. Each linear probe was trained independently for each dataset, with hyperparameters tuned using Optuna and scikit-learn.

Semantic segmentation and depth estimation were approached using patch-level features extracted from the last output layer of the frozen encoder. For semantic segmentation, a linear prediction head mapped patch tokens to class logits, producing a 32×32 logit map subsequently upsampled to 512×512 resolution using bilinear interpolation. For depth estimation, encoder features were first upsampled by a factor of four, concatenated with the CLS token, and passed to a linear head. Depth prediction was treated as a soft classification task using AdaBins with 256 uniformly distributed bins.

The 15 datasets used for evaluation included five ImageNet-CoG levels for concept generalization, eight small-scale fine-grained datasets (Aircraft, Cars196, DTD, EuroSAT, Flowers, Pets, Food101, and SUN397), and two long-tail datasets (iNaturalist-2018 and iNaturalist-2019).

Data augmentation included random resized cropping to 224×224 pixels followed by random horizontal flipping, color jitter, grayscale transformation, Gaussian blur, and solarization. Unless stated otherwise, all teacher and student models employed ViT-Base architecture with a patch size of 16 and were trained for 100 epochs. Models utilizing teacher-dropping regularization were trained for 200 epochs. Notably, extending training duration alone yielded only marginal improvements in performance.

The distillation process minimized a weighted combination of cosine and smooth- [symbol] 1 losses computed between the outputs of the student and each teacher, consistent with previously described loss functions. Optimization was performed using Adam W with a learning rate of 3e-4, weight decay of 3e-2, and batch size of 512 distributed across four GPUs. A linear learning rate warmup was applied over the first 10 epochs, followed by a cosine decay schedule.

To address discrepancies in feature representations, feature statistics were equalized across tokens and teachers. Feature statistics for both CLS and patch tokens were analyzed for each teacher. Differences were observed in both norm and standard deviation across tokens within a model, as well as across models. For instance, the CLS token features of DINO exhibited twice the norm and standard deviation of its patch tokens. Similar inconsistencies were noted between DINO and DeiT-III features, as summarized in TABLE 11.

TABLE 11
Feature statistics obtained on the ImageNet-1K validation set.

| | Feature | Avg. norm | Avg. std | Avg. std per |
|---|---|---|---|---|
| Model | Type | per sample | per sample | dimension |
| DINO | CLS | 66.6 | 2.4 | 2.2 |
| DeiT-III | CLS | 23.3 | 0.8 | 0.5 |
| iBOT | CLS | 69.9 | 2.5 | 2.3 |
| DINO | Patch | 31.3 | 1.1 | 0.5 |
| DeiT-III | Patch | 26.2 | 0.9 | 0.5 |
| iBOT | Patch | 36.3 | 1.3 | 0.9 |
| dBOT-ft | Patch | 9.8 | 0.4 | 0.4 |

TABLE 11 reports feature statistics computed on the ImageNet-1K validation set. ‘CLS’ refers to features of the CLS token, while ‘Patch’ refers to patch token features, where the statistics are computed after global average pooling (GAP) applied spatially. ‘Avg. norm per sample’ and ‘Avg. std. per sample’ denote the average €2 norm and standard deviation across samples, respectively. ‘Avg. std. per dimension’ indicates variability across feature dimensions. For dBOT-ft, which lacked a CLS token, global average pooled features were used.

To mitigate the impact of such statistical inconsistencies during distillation, feature standardization 335a-n was applied to each teacher output. This involved normalizing features to zero mean and unit variance prior to computing the distillation loss 230. This approach harmonized feature distributions across tokens and across teachers. To facilitate practical applications, these normalization statistics were learned online during training using an exponential moving average.

TABLE 12
Component analysis for distillation from two teachers.

| | | | | | | | | | |
|---|---|---|---|---|---|---|---|---|---|
| Sr. | | | | | | IN-val | Transfer | Segmentation | Depth |
| No. | Model | std | DP | LP | tdrop | top-1 (↑) | top-1 (↑) | mIoU (↑) | RMSE (↓) |

Teacher Models

| | | | | | | | | | |
|---|---|---|---|---|---|---|---|---|---|
| 1 | DINO | — | — | — | — | 77.7 | 72.4 | 30.4 | 0.57 |
| 2 | DeiT-III | — | — | — | — | 83.6 | 68.5 | 32.3 | 0.589 |
| 3 | best | — | — | — | — | 83.6 | 72.4 | 32.3 | 0.57 |
| | teacher | | | | | | | | |

Multi-teacher distillation (DINO & DeiT-III teachers)

| | | | | | | | | | |
|---|---|---|---|---|---|---|---|---|---|
| 4 | basic | — | — | — | — | 78.7 | 73.1 | 33.9 | 0.56 |
| | setup | | | | | | | | |
| 5 | | ✓ | — | — | — | 81.4 | 73.8 | 36.1 | 0.558 |
| 6 | | ✓ | ✓ | — | — | 82.2 | 74.1 | 36.9 | 0.551 |
| 7 | UNIC | ✓ | ✓ | ✓ | — | 82.7 | 74.2 | 37.4 | 0.546 |
| 8 | | ✓ | ✓ | ✓ | ✓ | 83.2 | 73.5 | 37.3 | 0.547 |

Column legend: std: feature standardization, DP: dedicated projector heads for CLS/patch tokens, LP: ladder of projectors and tdrop: teacher dropping regularization.

TABLE 12 presents a component-wise analysis of multi-teacher distillation from two teachers. Reported metrics include: (1) image classification accuracy on ImageNet-1K (IN-val), (2) average top-1 accuracy across 15 transfer learning datasets, (3) semantic segmentation performance on ADE-20K, and (4) depth estimation accuracy on NYUv2. The upper section of TABLE 12 compares the performance of the self-supervised DINO and supervised DeiT-III across these evaluation axes. These models exhibit complementary strengths: DINO performs better on transfer learning, while DeiT-III achieves superior accuracy on the IN-val set. As shown in TABLE 12, models trained via distillation consistently outperformed baselines when feature standardization 335a-n was applied, for both image- and patch-level tasks (e.g., rows 4 vs. 5). Thus, feature standardization 335a-n can enhance the quality of multi-teacher distillation.

In some instances, projector heads were separately designed for CLS and patch tokens. In addition to statistical differences, CLS and patch tokens are conceptually distinct: the CLS token encodes global, image-level semantics, whereas patch tokens encode localized information. To capture these characteristics more effectively, experiments were conducted with dedicated teacher-specific projector heads for each token type. These heads were discarded post-distillation, hence, incurring no inference-time overhead. A comparison between rows 5 and 6 in TABLE 12 demonstrates that specialized projectors for CLS and patch tokens leads to further improvements. Accordingly, dedicated projectors can enhance distillation performance.

As further shown in TABLE 12, models produced or learned via disclosed multi-teacher distillation substantially outperform DINO on transfer learning and novel class classification tasks. The multi-teacher approach improves concept generalization.

To assess the discriminative power of patch tokens independently, the multi-teacher distillation models were evaluated on two dense prediction tasks: semantic segmentation and depth estimation, both using linear probes. TABLE 12 indicates that even a basic multi-teacher setup (row 4) surpassed the best teacher model (row 3). Moreover, performance improves further (row 6) when both feature standardization 335a-n and dedicated projector heads are used. For example, the student encoder 110 achieves a +4.6% improvement in mIoU compared to the best teacher on ADE-20K. These gains are particularly notable when compared against specialized dense prediction models. Specifically, the distilled encoder outperforms iBOT—a model trained with masked patch prediction known for dense prediction-achieving 36.9% mIoU versus iBOT's 36.6%. Thus, the disclosed multi-teacher distillation technique improves the discriminative power of patch tokens.

Additional performance gains can be observed using a ladder of projectors (TABLE 12, row 8), particularly for dense prediction tasks. The representation quality of patch tokens may be improved due to dense connections. Notable gains are also recorded in supervised classification: accuracy on ImageNet-1K is improved by +0.5%. The ladder of projectors provides tangible improvements for both CLS and patch token representations.

The basic (distillation) setup assumed equal representation of all teacher models in the student encoder 110. When feature standardization 335a-n was used alongside simple losses such as cosine and smooth- [symbol] 1, it became feasible to assess the degree to which each teacher was learned. This was achieved by comparing the magnitudes of the corresponding loss terms, which indicated the fidelity of student features to those of each teacher.

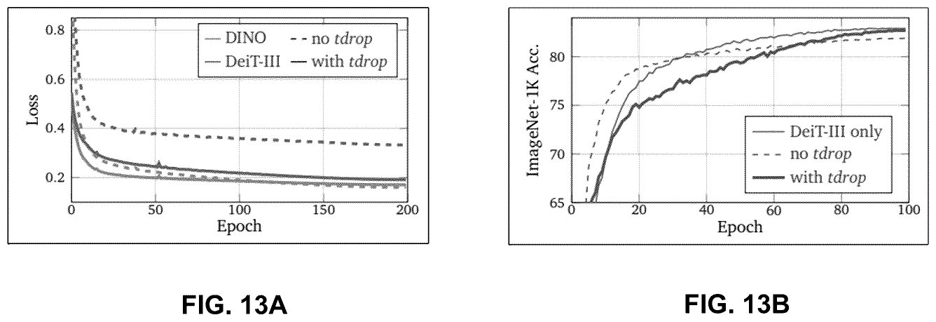

FIG. 13A illustrates teacher dropping regularization through visualizations of loss curves for each of the two teachers during multi-teacher distillation in accordance with an example implementation of the present disclosure. In FIG. 13A, the loss curves for UNIC models trained with the distillation setup (including feature standardization, dedicated projectors and no teacher dropping) are shown in dashed lines. These curves reveal that the DINO teacher was learned more effectively than DeiT-III. Some type of intervention may be needed to correct unequal teacher contributions. This also explains subpar performance on ImageNet-1K (row 6 versus row 2), the domain where DeiT-III excels at. This raised the question: what if DINO was not even part of the distillation process?

FIG. 13B illustrates teacher dropping regularization through visualizations of ImageNet-1k top-1 accuracy when distilling from DINO and DeiT-III together versus distilling only from DeiT-III. The above question is addressed in FIG. 13B by comparing ImageNet-1K performance during distillation from both DINO and DeiT-III versus distillation from DeiT-III alone. The student encoder 110 without teacher dropping (dashed line) learns faster using multiple teachers (DINO and DeiT-III) but exhibited faster early training but converges to a lower accuracy. These results suggest that the student may exploit features from the additional teacher to ramp up performance faster but fails to reach the performance (accuracy) achievable from a single, specialized teacher such as DeiT-III (which yielded 83.1% Top-1 accuracy).

The findings in FIG. 13A and FIG. 13B implied that some form of loss balancing may be beneficial. While loss balancing is common in multi-task learning, manual weighting of individual loss components can be cumbersome for multi-teacher setups, particularly when several loss terms are involved. The case of multi-teacher distillation over standardized features and simple regression losses is simpler than multi-task learning when it comes to balancing the losses. The magnitudes of the losses are comparable and thus can be used for balancing and pacing the distillation process.

Referring back to FIG. 13A, the effects of teacher dropping during multi-teacher distillation are also illustrated in FIG. 13A. With teacher dropping enabled, loss magnitudes across teachers became more similar as training progressed (solid lines), leading to better balance among teacher contributions.

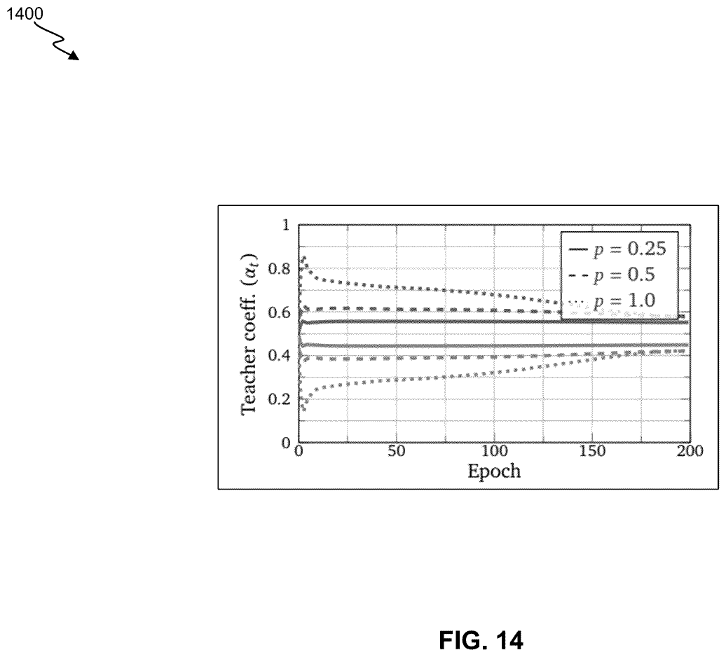

FIG. 14 shows plots of teacher coefficients at during distillation for various values of p from DeiT and DINO in accordance with some example implementations of the present disclosure. FIG. 14 shows the evolution of teacher coefficients at throughout training or distillation. The plots show that teacher utilization becomes more balanced and stable after several training epochs. Thus, teachers are distilled equally well with teacher dropping regularization.

In all experiments, pretrained weights for teacher encoders 220a-n were obtained from the official repositories. For the ladder of projectors, hidden dimensions dₕ and

$${d}_{h}^{l}$$

where set to 3072 and 768, respectively. Teacher dropping was applied at the image level with a drop probability of 0.25 when using two teachers, and 0.5 when using four.

Further, teacher dropping technique is also compared against several alternative strategies, including manual loss balancing, random dropping, and the Adaloss loss balancing method. All comparisons were conducted starting from the configuration in row 6 of TABLE 12. None of the alternatives yielded noticeable improvements; in fact, none outperformed teacher dropping (as shown in row 8). A comparison of loss balancing techniques across the four evaluation tasks is presented in TABLE 13. In terms of both performance and simplicity, the disclosed teacher dropping technique is unparalleled.

TABLE 13
Loss balancing techniques.

| | IN-val | Transfer | Segmentation | Depth |
|---|---|---|---|---|
| | top-1 | top-1 | mIoU | RMSE |
| Method | (↑) | (↑) | (↑) | (↓) |
| Manual balancing | | | | |
| DINO × 1 + DeiT-IIIX1 + | 82.2 | 74.5 | 38.5 | 0.539 |
| iBOT × 1 + dBOT-ft × 1 | | | | |
| DINO × 4 + DeiT-IIIX1 + | 80.6 | 74 | 36.1 | 0.549 |
| iBOT × 1 + dBOT-ft × 1 | | | | |
| DINO × 1 + DeiT-IIIX4 + | 83.2 | 74 | 37.4 | 0.548 |
| iBOT × 1 + dBOT-ft × 1 | | | | |
| DINO × 1 + DeiT-IIIX1 + | 81.1 | 74.1 | 38.2 | 0.533 |
| iBOT × 4 + dBOT-ft × 1 | | | | |
| DINO × 1 + DeiT-IIIX1 + | 83.5 | 74.2 | 38.4 | 0.532 |
| iBOT × 1 + dBOT-ft × 4 | | | | |
| Automatic balancing | | | | |
| AdaLoss | 81.9 | 74.5 | 38.4 | 0.536 |
| Teacher dropping (tdrop) | 83.1 | 74.4 | 38.8 | 0.533 |

TABLE 13 summarizes performance from different loss balancing techniques used in distillation from all four teachers (DINO, DeiT-III, iBOT, and dBOT-ft). The best and second-best results for each metric are highlighted in bold and underlined, respectively. All experiments performed over the base setup, i.e. using feature standardization 335a-n and dedicated projectors for CLS/patch tokens and without using a ladder of projector heads.

The impact of teacher dropping probability ρ was evaluated across a range of values. Model performance remains stable for different values. Higher values of ρ tend to favor performance on ImageNet-1K, albeit with slight reductions on tasks where the student model already outperforms the best teacher. These results are detailed in TABLE 14.

TABLE 14
Impact of teacher dropping (tdrop) probability and granularity.

| tdrop | | | IN-val | Transfer | Segmentation | Depth |
|---|---|---|---|---|---|---|
| gran. | prob. | LP | top-1 (↑) | top-1 (↑) | mIoU (↑) | RMSE (↓) |
| Image | 0.00 | — | 83.0 | 74.4 | 39.1 | 0.518 |
| Image | 0.25 | — | 83.1 | 74.3 | 38.7 | 0.522 |
| Image | 0.50 | — | 83.5 | 74.3 | 38.4 | 0.525 |
| Image | 1.00 | — | 83.5 | 73.9 | 37.9 | 0.530 |
| Patch | 0.50 | — | 83.2 | 74.3 | 38.7 | 0.532 |
| Patch | 1.00 | — | 83.3 | 74.1 | 38.0 | 0.533 |
| Image | 0.00 | ✓ | 83.2 | 74.8 | 39.7 | 0.505 |
| Image | 0.25 | ✓ | 83.6 | 74.5 | 39.4 | 0.506 |
| Image | 0.50 | ✓ | 83.8 | 74.5 | 38.9 | 0.515 |
| Image | 1.00 | ✓ | 83.7 | 73.6 | 38.1 | 0.530 |

TABLE 14 reports the effects of varying both the teacher dropping probability ρ and the granularity (image-level vs. patch-level) for distillation from iBOT and dBOT-ft. All configurations employed feature standardization 335a-n and dedicated projectors without using the ladder of projectors.

As shown in TABLE 12 (row 8), teacher dropping improves performance on ImageNet-1K, i.e., the task where multi-teacher distilled models were previously lacking in performance. When combined with the ladder of projectors, ImageNet accuracy reaches 83.2%, just 0.4% below the highly optimized DeiT-III (row 3). This combination has also closed the performance gap between multi-teacher and single-teacher distillation. Notably, teacher dropping alone contributed a +0.5% gain over the prior best multi-teacher configuration (rows 7 vs. 8). Teacher dropping regularization emerged as a simple and effective mechanism for balancing teachers in multi-teacher distillation.

In another set of experiments, distillation is performed using pairs of teacher models, including DeiT-III and DINO, as well as iBOT and dBOT-ft. An additional configuration distills from all four teachers simultaneously. In all cases, publicly available ViT-Base/16 teacher models are used that are pretrained on the ImageNet-1K dataset.

The protocol used in these experiments follows the procedures summarized previously. Evaluation is conducted on ImageNet-v2, a variant of the standard ImageNet validation set, and on two domain shift datasets: ImageNet-R and ImageNet-Sketch. Performance is additionally reported across 15 transfer learning benchmarks, grouped into concept generalization, long-tail, and small-scale fine-grained recognition tasks, including datasets such as Aircraft, Cars196, DTD, EuroSAT, Flowers, Pets, Food101, and SUN397. Hyperparameters were selected based on the performance on ImageNet-1K.

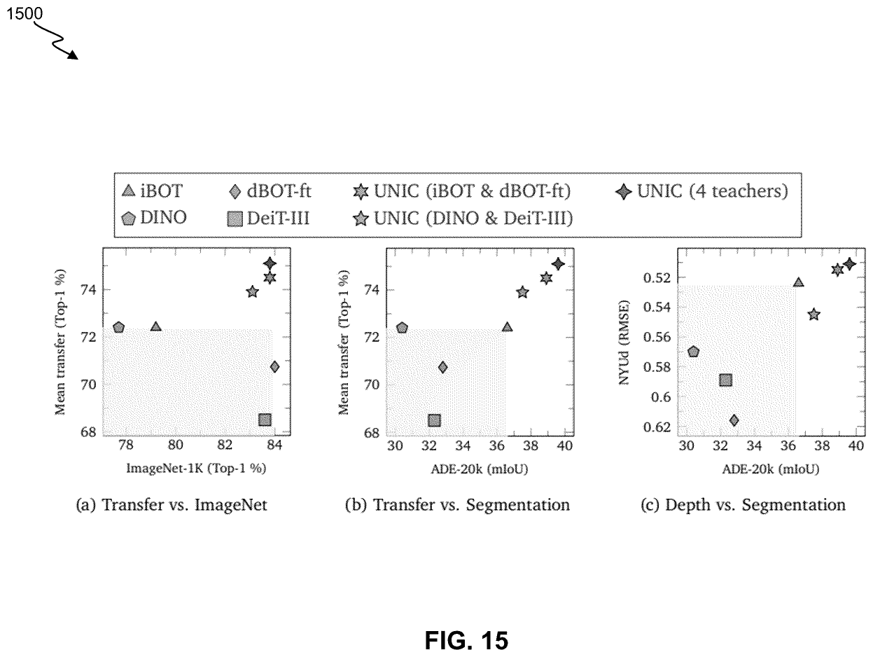

FIG. 15 illustrates the performance comparison of different UNIC encoders on different pairs of tasks. The performance of different UNIC encoders across various teacher combinations is shown in FIG. 15. Encoders were distilled from DINO & DeiT-III, iBOT & dBOT-ft, and all four teachers. Results are reported on ImageNet-1K (a), over 15 transfer learning tasks (a, b), semantic segmentation (b, c), and depth estimation (c). Performance results for the UNIC models distilled from different teacher combinations are summarized in TABLE 15 and FIG. 15.

TABLE 15
Relative gains using the disclosed UNIC.

| Model | | | | | | | | |
|---|---|---|---|---|---|---|---|---|
| Teachers | IN-1K | IN-V2 | DS | CoG | LT | FG | ADE20K | NYUd |
| DINO | 77.7 | 74.0 | 32.6 | 65.3 | 81.6 | 53.0 | 30.4 | 0.57 |
| DeiT-III | 83.6 | 79.6 | 45.3 | 64.0 | 77.3 | 44.8 | 32.3 | 0.59 |
| iBOT | 79.2 | 75.3 | 33.3 | 65.9 | 81.4 | 52.4 | 36.6 | 0.52 |
| dBOT-ft | 84.0 | 80.0 | 44.5 | 65.8 | 78.8 | 50.7 | 32.8 | 0.61 |
| UNIC | 83.8 | 80.3 | 45.0 | 68.2 | 83.7 | 57.9 | 39.6 | 0.51 |
| rel. gains | ↓−0.2 | ↑0.4 | ↓0.6 | ↑3.5 | ↑2.6 | ↑9.2 | ↑8.2 | ↑2.4 |

TABLE 15 presents relative gains obtained using a UNIC encoder distilled from four teachers (DINO, DeiT-III, iBOT, dBOT-ft) compared to the best-performing teacher for each task. UNIC solves all classification tasks using a single encoder and without task-specific parameters. Evaluation axes include DS (domain shift datasets: ImageNet-R and Sketch), CoG (concept generalization via five ImageNet-CoG levels), LT (long-tail datasets: iNaturalist-2018 and 2019), and FG (fine-grained datasets: Aircraft, Cars196, DTD, EuroSAT, Flowers, Pets, Food101, and SUN397).

Several observations can be derived from this set of experiments. First, stronger teachers yield stronger students: iBOT and dBOT-ft produce higher-performing UNIC students than DINO and DeiT-III.

Second, incorporating more teachers improves performance. Combining all four teachers leads to a generally stronger student model, even when the additional teachers are not individually superior.

Third, UNIC models excel at image-level classification. The UNIC encoder distilled from four teachers achieves 83.8% top-1 accuracy on ImageNet-1K and 80.3% on transfer tasks, closely matching the best teacher model (dBOT-ft) which achieves 84% and 80%, respectively. UNIC exceeds DINO/iBOT by an average of +2.7% on transfer learning benchmarks.

Fourth, impressive gains on transfer to small fine-grained datasets: UNIC achieves a +9.2% relative improvement on average on eight small-scale datasets, including domains far outside ImageNet that is used for all teachers and distillation, such as satellite imagery and textures. This highlights the benefit of using diverse, complementary teachers.

Fifth, improvements in dense prediction via linear probing. Substantial gains are observed for segmentation and depth estimation. For example, UNIC outperforms iBOT by +8.2% on ADE-20K. Although linear probing is not optimal for these tasks, it is useful for evaluating the discriminative quality of encoder representations.

Sixth, preservation of top teacher performance under domain shift. UNIC retains the strong performance of DeiT-III on domain shift benchmarks, achieving 51.4% and 38.5% top-1 accuracy on ImageNet-R and Sketch, respectively, compared to DeiT-III's 51.4% and 39.3%.

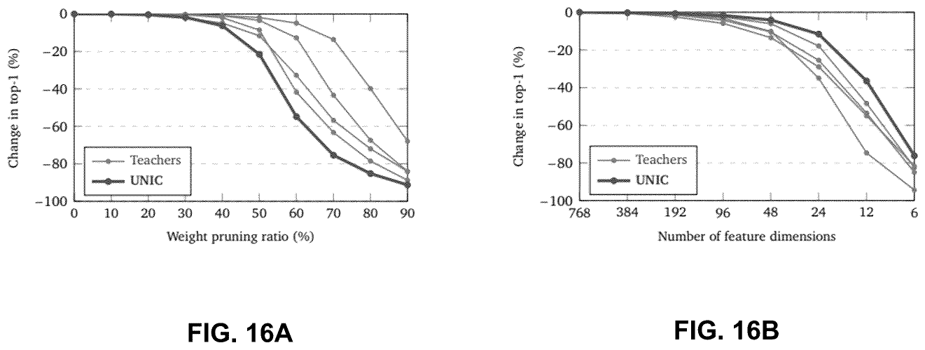

FIG. 16A illustrates top-1 accuracy drop after [symbol] 1-norm-based unstructured weight pruning for UNIC and teacher models, in accordance with an example implementation of the present disclosure. Network utility analysis is performed via linear probing on ImageNet-1K for the four teachers and the UNIC encoder distilled from all four teachers. For each model, before training linear probes, weight pruning is performed (results shown in FIG. 16A) or dimension reduction of features is achieved via PCA (results shown in FIG. 16B). The relative drop in accuracy is measured in each case. UNIC exhibits greater resilience to both weight pruning and dimensionality reduction.

To better understand why multi-teacher distillation produces stronger encoders, performance is analyzed under encoder weight pruning and PCA-based dimensionality reduction. Pruning is performed using unstructured [symbol] 1-norm-based weight elimination, and PCA is applied with whitening. From FIG. 16A, UNIC's performance drops more rapidly with pruning compared to its teachers, indicating better synergy among encoder weights.

FIG. 16B shows top-1 accuracy variation under PCA-based feature dimensionality reduction for UNIC and teacher models, in accordance with an example implementation of the present disclosure. In FIG. 16B, it can be observed that the distilled encoder, i.e., UNIC preserves its base performance better than all the teachers as the number of dimensions is reduced with PCA. The feature space of UNIC can be represented better with fewer principal components, maybe due to higher entanglement in the original feature space. Hence, UNIC encoders are more resilient to dimensionality reduction.

In a further example, the distillation procedure is extended to larger teacher models trained on large arbitrary datasets, specifically MetaCLIP ViT-Huge/14 and DINOv2 ViT-Giant/14. A ViT-Large/14 student is trained from these teachers in two phases: an initial distillation phase at resolution 224 for 200 epochs, followed by fine-tuning at resolution 336 for 100 additional epochs. A teacher dropping probability of 0.25 is employed. For distillation with higher-dimensional representations, the student's projector (LP) layers are adjusted accordingly. Specifically, the hidden dimensions dₕ and

$${d}_{h}^{l}$$

are set to 4096 and 1024, respectively.

TABLE 16
Results after distilling MetaCLIP-Huge/14 and
DINOv2-Giant/14 into a ViT-Large student.

| | k-NN | Zero-shot | ADE-20K |
|---|---|---|---|
| Model | top-1 acc. | top-1 acc. | mIoU |
| Teacher Models | | | |
| MetaCLIP-Huge/14 | 82.1 | 80.5 | 35.4 |
| DINOV2-Giant/14-reg | 83.4 | — | 48.7 |
| AM-RADIO | 84.8 | 80.4 | 48.1 |
| UNIC-L | 85.6 | 81.4 | 48.3 |

Results are reported in TABLE 16, including performance on ImageNet-1K using k-nearest neighbors (k-NN) and zero-shot classification, as well as semantic segmentation on ADE-20K. In most cases, the UNIC encoder outperforms both teacher models, confirming the benefits of teacher dropping and the ladder of projectors.

TABLE 17
Effect of finetuning UNIC models at a high input resolution.

| | | | k-NN | Zero-shot | ADE-20K |
|---|---|---|---|---|---|
| Model | Epochs | Resolution | top-1 acc. | top-1 acc. | mIoU |
| UNIC-L* | 200 | 224 | 85.0 | 80.7 | 47.7 |
| | +100 | 336 | 85.1 | 81.1 | 49.1 |
| UNIC-L | 200 | 224 | 85.4 | 81.2 | 47.1 |
| | +100 | 336 | 85.6 | 81.4 | 48.3 |

TABLE 17 presents the effect of high-resolution fine-tuning when distilling from MetaCLIP-H/14 and DINOv2-G/14 into a ViT-Large/14 student (referred to as UNIC-L). The model is first distilled from scratch at resolution 224 for 200 epochs and then fine-tuned at 336 resolution for 100 more epochs. Models denoted with an asterisk (*) do not employ a ladder of projectors. A teacher dropping probability of 0.25 is used in all cases.

Moreover, when utilizing the ladder of projectors, features from intermediate blocks of the student encoder 110 are projected through teacher-specific MLPs and summed together with the outputs of the projector head attached to the last encoder layer. The effect of varying the hidden dimension

$${d}_{h}^{l}$$

of the non-final block (768 by default) these MLPs and the choice of intermediate blocks included in the ladder (by default, all, i.e., {1, . . . , 11}) is evaluated in accordance with an example implementation of the present disclosure. Results are reported in TABLE 18 for distillation from DINO and DeiT-III without using teacher dropping but using feature standardization 335a-n and dedicated projectors. The default values used in the experiments are emphasized in bold.

TABLE 18
Architecture for the ladder of projector.

| | | IN-val | Transfer | Segmentation | Depth |
|---|---|---|---|---|---|
| Hidden | | top-1 | top-1 | mIoU | RMSE |
| dim. | Blocks | (↑) | (↑) | (↑) | (↓) |
| 64 | {1, . . . , 11} | 81.9 | 74.5 | 36.1 | 0.549 |
| 192 | {1, . . . , 11} | 82.3 | 74.5 | 36.9 | 0.540 |
| 384 | {1, . . . , 11} | 82.5 | 74.4 | 37.8 | 0.547 |
| 768 | {1, . . . , 11} | 82.7 | 74.2 | 37.4 | 0.546 |
| 1536 | {1, . . . , 11} | 82.7 | 74.5 | 37.7 | 0.544 |
| 768 | {6} | 82 | 74.6 | 36.7 | 0.545 |
| 768 | {3, 6, 9} | 82.3 | 74.3 | 37.3 | 0.545 |
| 768 | {9, 10, 11} | 82 | 74.4 | 37.1 | 0.542 |
| 768 | {2, 4, 6, 8, 10} | 82.5 | 74.4 | 37.8 | 0.541 |

TABLE 18 presents the impact of modifying the hidden dimension and selection of blocks in the ladder structure. Increasing the hidden dimension improves ImageNet-1K performance up to a saturation point near 384 for semantic segmentation. A dimension of 768 is selected to balance accuracy and model size. Performance is stable across different block selections, with full inclusion of all intermediate blocks yielding the best results on ImageNet-1K.

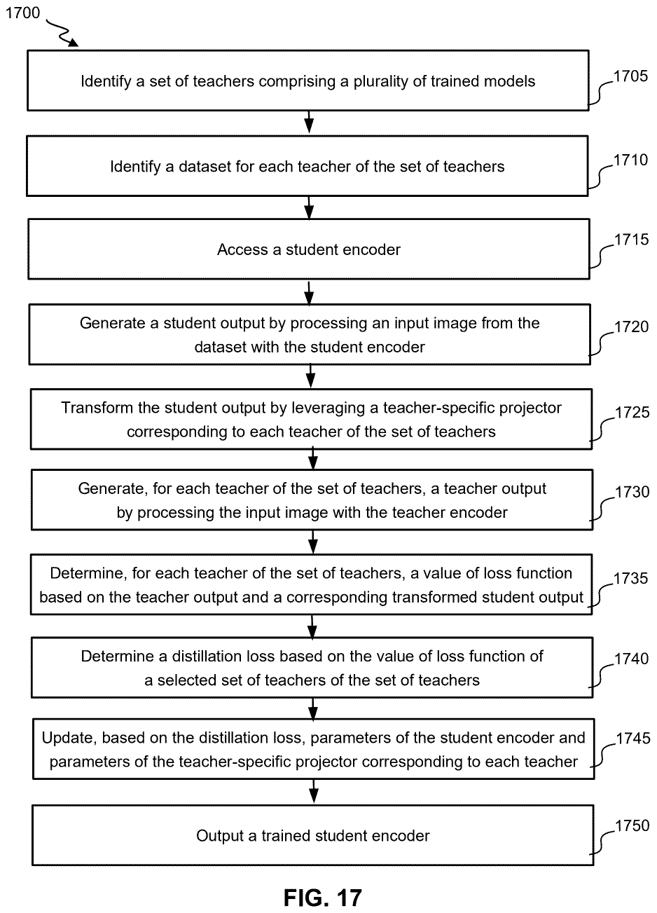

FIG. 17 shows an example flowchart of a system performing multi-teacher distillation to train the student encoder 110 in accordance with some embodiments of the present disclosure. The blocks in flowchart are illustrated in a specific order, while the order can be modified, for example, some blocks may be performed before others, and some blocks may be performed simultaneously. The blocks can be performed by hardware or software or a combination thereof. The process at block 1705 may include identifying a set of teachers comprising a plurality of trained models. Each teacher of the set of teachers may include a teacher encoder. Also, each trained model of the plurality of trained models comprises a neural network model.

In some instances, the set of teachers may include at least one task-agnostic teacher, e.g., foundation models. In some other instances, the set of teachers may include at least one specialized teacher, e.g., MASt3R for 3D scene reconstruction. Each teacher of the set of teachers may be trained on a respective training dataset. Each teacher of the set of teachers may be designed for one or more tasks that can be different than other teachers of the set of teachers. In some instances, one or more of the plurality of teachers are heterogeneous teachers 105. The set of teachers may comprise the heterogenous teachers 105 that may include task-agnostic teachers and specialized teachers.

A dataset can be identified for each teacher of the set of teachers for multi-teacher distillation, at block 1710. The dataset can be obtained from the respective training dataset of each teacher. The distillation data 205 may include the dataset corresponding to each teacher of the set of teachers.

Further, the student encoder 110 can be accessed, at block 1715. In some embodiments of the present disclosure, the student encoder 110 can be based on a vision transformer (ViT) and the set of teachers (or the plurality of teachers) may be comprised of two or more vision models.

The process at block 1720 may include generating a student output by processing the input image 210 from the dataset or the distillation data 205. The student output may be comprised of a set of feature vectors. The set of feature vectors may include patch token features and the CLS feature. In some embodiments, a task output of the input image 210 can be one or more of semantic segmentation, monocular depth estimation, 3D pose understanding, and 3D scene reconstruction. The 3D scene reconstruction may include recovering camera parameters of a scene. Moreover, performing 3D pose understanding may include recovering a mesh of a human.

The student output can be transformed by leveraging a teacher-specific projector corresponding to each teacher of the set of teachers, at block 1725. In some instances, the teacher-specific projector corresponding to each teacher of the set of teachers includes a transformer projector. The transformer projector may share information across the set of feature vectors for corresponding to patches of the input image 210.

In some other instances, the teacher-specific projector corresponding to each teacher of the set of teachers comprises a ladder of projectors. The ladder of projectors may include a plurality of multi-layer perceptrons that are attached to intermediate layers and a final layer (or a last layer) of the student encoder 110. For one or more of the teachers, the teacher-specific projectors 215a-n appended at different intermediate layers of the student are also further accompanied by loss function for distilling the features of the intermediate layers.

For each teacher of the set of teachers, a teacher output can be generated by processing the input image 210 with the teacher encoder, at block 1730. In some instances, the teacher output corresponding to each teacher of the set of teachers may be normalized, for example, by using exponential moving average.

Afterwards, for each teacher of the set of teachers, a value of loss function can be determined based on the teacher output and a corresponding transformed student output, i.e., an output of the corresponding teacher-specific projector, at block 1735. In some instances, the loss function may include cosine similarity and smooth-L1 loss.

The distillation loss 230 can be determined based on the value of loss function of a selected set of teachers of the set of teachers, at block 1740. In some instances, the selected set of teachers may include each teacher in the set of teachers. In some instances, the distillation loss 230 for the input image 210 of the distillation data 205 may be computed by summing up the value of loss function for each teacher of the set of teachers. In some other instances, regularization using teacher dropping can be performed to balance the distillation loss 230. During teaching dropping, the selected set of teachers may include a subset of teachers from the set of teachers.

The process at block 1745 includes updating parameters of the student encoder 110 and parameters of the teacher-specific projector corresponding to each teacher of the set of teachers based on the distillation loss 230.

The process from block 1720 to block 1745 may be repeated for each image of the dataset or the distillation data 205. The multi-teacher distillation process may be performed by utilizing each image of the dataset corresponding to each teacher of the set of teachers or the distillation data 205.

Finally, at block 1750, a trained student encoder can be output. In some embodiments of the present disclosure, each teacher-specific projector can be discarded after training the student encoder 110. Moreover, a decoder of one of the plurality of trained models may be fine-tuned while keeping the trained student encoder frozen. In some other embodiments, the teacher-specific projectors can be kept depending on the downstream task.

According to some aspects of the present disclosure, the trained student encoder may be accessed to perform a set of downstream tasks by using the trained student encoder and a decoder corresponding to the plurality of trained models, respectively. The set of downstream tasks may include more than one task. The set of downstream tasks may be performed by sharing the trained student encoder with each decoder corresponding to the plurality of trained models. The set of downstream tasks may comprise one or more object detection tasks that may perform one or more of: semantic segmentation, monocular depth estimation, 3D pose understanding, and 3D scene reconstruction.

According to some embodiments, one or more input images may be captured with a camera mounted on an autonomous system. The autonomous system may be controlled based on a set of object detection tasks performed on the one or more input images. The set of object detection tasks may comprise one or more of: semantic segmentation, monocular depth estimation, 3D pose understanding, and 3D scene reconstruction.

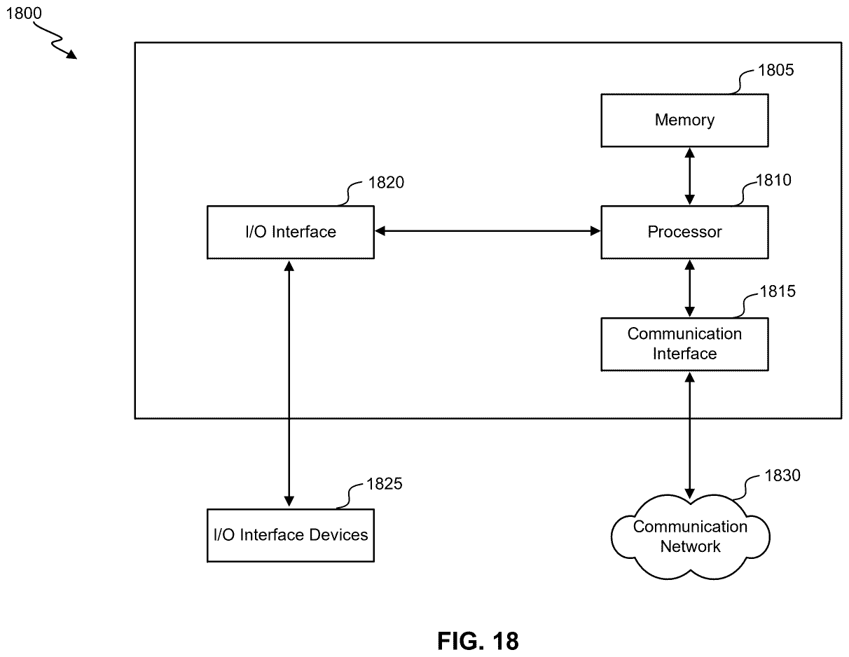

FIG. 18 is a block diagram of an example computing system 1800 that may be utilized to perform one or more aspects of the disclosure described herein. For example, in some implementations, the example computing system 1800 may be utilized to perform heterogeneous teachers distillation or co-distillation. The example computing system 1800 typically includes at least one processor 1810 that communicates with several peripheral devices via buses. These peripheral devices may further include, for example, a memory 1805 (e.g., RAM, a magnetic hard disk or an optical storage disk), Input and Output (I/O) interface devices 1825 via an I/O interface 1820 and a communication network 1830 via a communication interface 1815.

The I/O interface devices 1825 allow user interaction with the example computing system 1800. Input interface devices may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into the example computing system 1800 or onto the communication network 1830. Output interface devices may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the example computing system 1800 to the user or to another machine or computing device.

The communication interface 1815 provides an interface to the communication networks 1830 and is coupled to corresponding interface devices in other computing devices. Some of the examples of the communication interfaces 1815 are a modem, digital subscriber line (“DSL”) card, cable modem, network interface card, wireless network card, or other interface device capable of wired, fiber optic, or wireless data communications.

Storage systems store programming and data constructs that provide the functionality of some, or all of the modules described herein. These software modules are generally executed by the processor 1810 alone or in combination with other processors. The memory 1805 used in the example computing system 1800 can include several memories including a main random-access memory (RAM) for storage of instructions and data during program execution, a mass storage device that provides persistent storage for program and data files, and may include a hard disk drive, a floppy disk drive along with associated removable media, a CD-ROM drive, a read only memory (ROM) in which fixed instructions are stored, an optical drive, or removable media cartridges. The modules implementing the functionality of certain implementations may be stored in the mass storage system, or in other machines accessible by the processor(s) 1810 via the I/O interface 1820.

The example computing system 1800 can be of varying types including a workstation, server, computing cluster, blade server, server farm, or any other data processing system or computing device. Due to the ever-changing nature of computers and networks, the description of the example computing system 1800 depicted in FIG. 18, is intended only as a specific example for purposes of illustrating some implementations. Many other configurations of the example computing system 1800 are possible to have more or fewer components than the computing device depicted in FIG. 18.

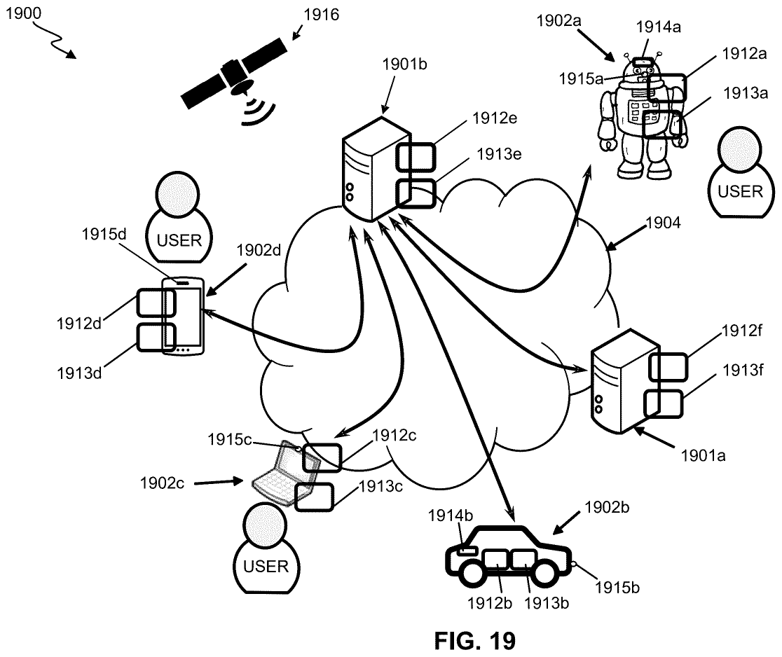

FIG. 19 illustrates an example system architecture in which the methods according to this disclosure may be performed. The disclosed methods or techniques such as heterogeneous teachers distillation or co-distillation may be implemented within a system 1900 architected as illustrated in FIG. 19, which includes servers 1901 and one or more client devices 1902 that communicate over a network 1904 (which may be wireless and/or wired) such as the Internet for data exchange. Servers 1901 and the client devices 1902 include one or more processors 1912 and memory 1913 such as a hard disk. The client devices 1902 may be any device that communicates with servers 1901, including autonomous robot 1902a, autonomous vehicle 1902b, computer 1902c, or cell phone 1902d, which are equipped with an imaging device 1915 for acquiring images of a scene (i.e., a device for acquiring images or video, such as cameras and cell phones). The acquired images of a scene using the imaging device 1915 can be transformed into embeddings using the universal encoder (e.g., DUNE or the trained student encoder) and can be used with multiple task-specific decoders to solve multiple tasks (e.g., 2D or 3D vision tasks). In one example, autonomous robot 1902a and autonomous vehicle 1902b are located using positioning system 1914 communicating with geo-positioning system (GPS) 1916, or, alternatively or in combination with, a cellular positioning system, an indoor positioning system (IPS), including beacons, RFID, WiFi and geomagnetic, or a combination thereof.

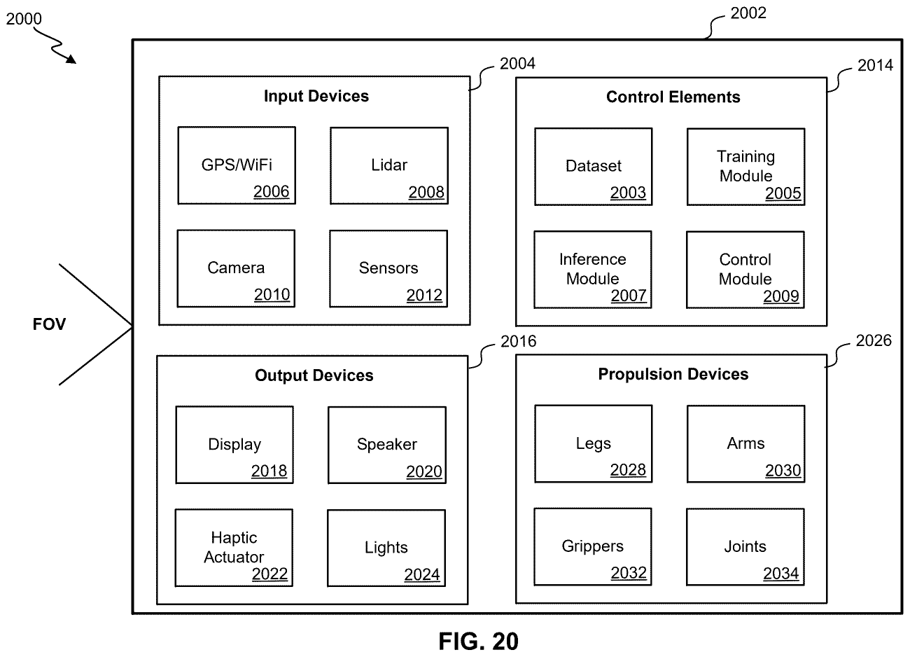

FIG. 20 is a functional block diagram of an example control system of an autonomous machine 2002, such as autonomous robot 1902a or autonomous vehicle 1902b shown in FIG. 19. The autonomous machine 2002, which may be mobile or stationary and indoor or outdoor, and may include one or more of the following elements: input devices 2004, control elements 2014, output devices 2016 (e.g., display 2018, speakers 220, haptic actuator 2022, lights 2024), and propulsion devices 2026 (e.g., legs 2028, arms 2030, grippers 2032, and joints 2034).

The input devices 2004 may include GPS/Wi-Fi 2006, Lidar 2008, camera 2010, and sensors 2012. The camera 2010 may include grayscale, or red, green, blue (RGB) sensors for capturing images within a predetermined field of view (FOV), or which may update (capture images) at a predetermined frequency, such as 60 hertz (Hz), 120 Hz, or another suitable frequency. The sensors 2012 may include but not limited to temperature sensor, rain sensor, force sensor, torque sensor, and the like.

In one example, the server 1901b (with processors 1912e and memory 1913e) as shown in FIG. 19 may include an inference module 2007 and a control module 2009 in memory 1913e containing functionality for controlling autonomous machine 2002, and the server 1901a may include training module 2005 and dataset 2003 for distilling the universal encoder to the inference module 2007 (such as co-distillation to generate the trained student encoder as disclosed herein). In alternate embodiments, the modules 2007, 2009, 2005, and 2003 may be implemented in memory 1913 of the autonomous machine 2002, or a combination thereof (e.g., modules 2007 and 2009 implemented in memory 1913 of the autonomous machine 2002 and modules 2005 and 2003 implemented in memory 1913f on server 1901a). In another embodiment, it is noted that the two servers 1901a and 1901b may be merged.

The autonomous machine 2002 may be powered, such as via an internal battery and/or via an external power source, such as alternating current (AC) power. AC power may be received via an outlet, a direct connection, etc. In various implementations, the autonomous machine 2002 may receive power wirelessly, such as inductively. In alternate embodiments, the autonomous machine 2002 may include alternate propulsion devices 2026, such as one or more wheels, one or more treads/tracks, one or more propellers, and/or one or more other types of devices configured to propel the autonomous machine 2002 forward, backward, right, left, up, and/or down. In operation, the control module 2009 actuates the propulsion device(s) 2026 to perform tasks issued by the inference module 2007. The inference module 2007 may utilize the universal encoder along with the task specific decoders to generate multiple outputs (output from each decoder) based on an input image from the imaging device 1915 or the camera 2010. The inference module 2007 may provide input to control module 2009 to carry out a given task or movement.

Some embodiments of the present disclosure include a system including one or more data processors. In some embodiments, the system includes a non-transitory computer-readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification, and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
accessing a trained student encoder; and
performing a set of downstream tasks using the trained student encoder and a decoder corresponding to a plurality of trained models, respectively;
wherein the trained student encoder is trained by:
identifying a set of teachers comprising the plurality of trained models, wherein:
each teacher of the set of teachers includes a teacher encoder,
each teacher of the set of teachers is designed for one or more tasks that are different than other teachers of the set of teachers, and
each teacher of the set of teachers is trained on a respective training dataset;
identifying, for each teacher of the set of teachers, a dataset;
accessing a student encoder;
for each image of the dataset corresponding to each teacher of the set of teachers:
generating a student output by processing the image with the student encoder, wherein the student output comprises a set of feature vectors;
transforming, for each teacher of the set of teachers, the student output by leveraging a teacher-specific projector corresponding to each teacher of the set of teachers;
generating, for each teacher of the set of teachers, a teacher output by processing the image with the teacher encoder;
determining, for each teacher of the set of teachers, a value of loss function based on the teacher output and an output of the corresponding teacher-specific projector;
determining a distillation loss based on the value of loss function of a selected set of teachers of the set of teachers; and
updating, based on the distillation loss, parameters of the student encoder and parameters of the teacher-specific projector corresponding to each teacher of the selected set of teachers;
wherein each teacher-specific projector is discarded after training the student encoder.

2. The computer-implemented method of claim 1, wherein the teacher-specific projector corresponding to each teacher of the set of teachers includes a transformer projector.

3. The computer-implemented method of claim 1, wherein the teacher-specific projector corresponding to each teacher of the set of teachers comprises a ladder of projectors, wherein the ladder of projectors includes a plurality of multi-layer perceptrons that are attached to intermediate layers and a final layer of the student encoder.

4. The computer-implemented method of claim 1, wherein the selected set of teachers includes each teacher in the set of teachers, and wherein the set of teachers includes at least one task-agnostic teacher that is trained on generic image datasets.

5. The computer-implemented method of claim 1, wherein the loss function includes cosine similarity and smooth-L1 loss.

6. The computer-implemented method of claim 1, further comprising:
performing regularization using teacher dropping to balance the distillation loss.

7. The computer-implemented method of claim 1, further comprising:
normalizing the teacher output corresponding to each teacher of the set of teachers by using exponential moving average.

8. The computer-implemented method of claim 1, wherein the student encoder is based on a vision transformer and the set of teachers comprises two or more vision models.

9. The computer-implemented method of claim 1, wherein the set of downstream tasks performed is greater than one task, and wherein the set of downstream tasks are performed by sharing the trained student encoder with each decoder corresponding to the plurality of trained models.

10. The computer-implemented method of claim 1, wherein the set of downstream tasks comprises one or more object detection tasks that perform one or more of: semantic segmentation, monocular depth estimation, 3D pose understanding, and 3D scene reconstruction; the computer-implemented method further comprising:
capturing one or more input images with a camera mounted on an autonomous system; and
controlling the autonomous system based on the set of object detection tasks performed on the one or more input images.

11. An autonomous system comprising:
a camera that captures one or more input images;
one or more data processors; and
a non-transitory computer-readable storage medium containing instructions which, when executed on the one or more data processors, cause the one or more data processors to perform a set of operations including:
accessing a trained student encoder;
performing a set of object detection tasks using the trained student encoder and a decoder corresponding to a plurality of trained models, respectively; and
controlling the autonomous system based on the set of object detection tasks performed on the one or more input images;
wherein the trained student encoder is trained by:
identifying a set of teachers comprising the plurality of trained models, wherein:
each teacher of the set of teachers includes a teacher encoder,
each teacher of the set of teachers is designed for one or more tasks that are different than other teachers of the set of teachers, and
each teacher of the set of teachers is trained on a respective training dataset;
identifying, for each teacher of the set of teachers, a dataset;
accessing a student encoder;
for each image of the dataset corresponding to each teacher of the set of teachers:
generating a student output by processing the image with the student encoder, wherein the student output comprises a set of feature vectors;
transforming, for each teacher of the set of teachers, the student output by leveraging a teacher-specific projector corresponding to each teacher of the set of teachers;
generating, for each teacher of the set of teachers, a teacher output by processing the image with the teacher encoder;
determining, for each teacher of the set of teachers, a value of loss function based on the teacher output and an output of the corresponding teacher-specific projector;
determining a distillation loss based on the value of loss function of a selected set of teachers of the set of teachers; and
updating, based on the distillation loss, parameters of the student encoder and parameters of the teacher-specific projector corresponding to each teacher of the selected set of teachers;
wherein each teacher-specific projector is discarded after training the student encoder.

12. The autonomous system of claim 11, wherein the teacher-specific projector corresponding to each teacher of the set of teachers includes a transformer projector.

13. The autonomous system of claim 11, wherein the teacher-specific projector corresponding to each teacher of the set of teachers comprises a ladder of projectors, wherein the ladder of projectors includes a plurality of multi-layer perceptrons that are attached to intermediate layers and a final layer of the student encoder.

14. The autonomous system of claim 11, wherein the selected set of teachers includes each teacher in the set of teachers, and wherein the set of teachers includes at least one task-agnostic teacher that is trained on generic image datasets.

15. The autonomous system of claim 11, wherein the loss function includes cosine similarity and smooth-L1 loss.

16. The autonomous system of claim 11, wherein the student encoder is based on a vision transformer.

17. The autonomous system of claim 11, wherein the set of object detection tasks comprises one or more of: semantic segmentation, monocular depth estimation, 3D pose understanding, and 3D scene reconstruction.

18. A computer-implemented method comprising:
accessing a trained student encoder; and
performing a set of downstream tasks using the trained student encoder and a decoder corresponding to a plurality of trained models, respectively;
wherein the trained student encoder is trained by:
identifying a set of teachers comprising the plurality of trained models, wherein:
each teacher of the set of teachers includes a teacher encoder,
each teacher of the set of teachers is designed for one or more tasks that are different than other teachers of the set of teachers, and
each teacher of the set of teachers is trained on a respective training dataset;
identifying, for each teacher of the set of teachers, a dataset;
accessing a student encoder;
for each image of the dataset corresponding to each teacher of the set of teachers:
generating a student output by processing the image with the student encoder, wherein the student output comprises a set of feature vectors;
transforming, for each teacher of the set of teachers, the student output by leveraging a teacher-specific projector corresponding to each teacher of the set of teachers, wherein the teacher-specific projector corresponding to each teacher of the set of teachers includes a transformer projector;
generating, for each teacher of the set of teachers, a teacher output by processing the image with the teacher encoder;
determining, for each teacher of the set of teachers, a value of loss function based on the teacher output and an output of the corresponding teacher-specific projector;
determining a distillation loss based on the value of loss function of a selected set of teachers of the set of teachers; and
updating, based on the distillation loss, parameters of the student encoder and parameters of the teacher-specific projector corresponding to each teacher of the selected set of teachers.

19. The computer-implemented method of claim 18, further comprising:
performing regularization using teacher dropping to balance the distillation loss.

20. The computer-implemented method of claim 18, wherein the set of downstream tasks comprises one or more object detection tasks that perform one or more of: semantic segmentation, monocular depth estimation, 3D pose understanding, and 3D scene reconstruction; the computer-implemented method further comprising:
capturing one or more input images with a camera mounted on an autonomous system; and
controlling the autonomous system based on the one or more object detection tasks performed on the one or more input images.
